(19) United States
(12) Patent Application Publication
(10) Pub. No.: US 2002/0098072 A1
(43) Pub. Date: Jul. 25, 2002

(54) Dual bladed robot apparatus and associated method

(75) Inventor: Satish Sundar, Milpitas, CA (US)

Correspondence Address: Patent Counsel, Applied Materials, Inc., 3050 Bowers Avenue, P.O. Box 450A, Santa Clara, CA, 95052, US

(73) Assignee: Applied Materials, Inc.

(21) Appl. No.: 09/765,830

(22) Filed: Jan. 19, 2001

(51) Int. Cl. B66C 23/00

(52) U.S. Cl. 414/744.5

(57) ABSTRACT

A robot apparatus is to be mounted on a robot hub, and includes a main robot link, a first robot extension arm, a second robot extension arm, a first robot blade, a second robot blade. A hub motor, a first extension motor, and a second extension motor. The main robot link is fixedly mounted to the robot hub. The first robot extension arm is rotatably mounted to a first end of the main robot link. The second robot extension arm is rotatably mounted to a second end of the main robot link. The first end of the main robot link is located on a distal end of the main robot link from the second end of the main robot link. The first robot blade is mounted to the first robot extension arm. The second robot blade is mounted to the second robot extension arm. The hub motor provides controllable rotational motion of the main robot link about the robot hub. The first extension motor is configured to provide controllable simultaneous extension or retraction of the first robot extension arm and the first robot blade. The second extension motor is configured to provide controllable simultaneous extension or retraction of the second robot extension arm and the second robot blade.

### BACKGROUND OF THE DISCLOSURE

1. Field of the Invention

The invention relates to robots. More particularly, the invention relates to a dual bladed robot device.

2. Description of the Prior Art

Processing semiconductor substrates requires a variety of distinct sequentially applied processes. Examples of processes that are applied to semiconductor substrates include physical vapor deposition (PVD), chemical vapor deposition (CVD), electroplating, electroless deposition, other deposition, other etching, and/or other cleaning processes. Each one of these varied processes are typically performed within a process cell that is configured to perform that particular process or series of processes. An assemblage of a plurality of process cells and other cells opening onto a transfer cell is typically referred to as a cluster tool. Robots are typically used to transfer the substrates to/from multiple cells. The plurality of process cells included in a cluster tool extend externally of, and are in communication with, a transfer cells to define the cluster tool. The cluster tool configuration provides for rapid transfer of substrates between the respective process cells by robots.

Robots are often configured and used to transfer one or more semiconductor substrate between multiple process cells. Robot motions are designed to optimize substrate throughput and minimize substrate or process cell contamination within cluster tools. Such limiting of contamination results from avoiding substrate contact with undesired chemicals, dried chemical crystals, or contaminated metal film deposition. Additionally, since substrates are frequently processed in hostile environments of temperature, pressure, chemicals conditions, robots used for substrate processing are generally configured to withstand the environments of process cells having a variety of different interior environments.

Robots can typically handle only one semiconductor substrate at any given time. Providing multiple independent robots within a cluster tool challenges basic robot motions because of limited space for each robot, and because multiple robots located close to each other may have conflicting motions. Configuring a plurality of independent robots to provide interrelated movement this requires complex robot design and complex software programming.

To overcome the difficulties present with multiple independent robots, multiple robots with interrelated or constrained robot motions are often used for semiconductor processing. Some dual-blooded robots are configured with two robot segments (typically arranged in a back-to-back configuration) that are attached to a single robot hub. Such robots used in back-to-back configurations are typically mechanically complex and involve a large number of link components. In these back-to-back robot configurations, the multiple robot linkages are constrained to operate dependently of each other. If one robot linkage is positioned to perform a useful operation, the second interrelated robot linkage is typically constrained in position so it cannot perform a useful task. As such, the second interrelated robot linkage must wait until the first robot linkage completes its task until the second robot linkage can perform another independent task.

Therefore, a need exists in the art for a dual bladed robot design that simplifies the programmed robot motion required to, and the mechanical structure of the robot assemblies necessary to, displace each robot blade. It would also be desirable to provide a configuration by which the robot arms can be extended or retracted either independently or dependently of each other.

### BRIEF DESCRIPTION OF THE DRAWINGS

The teachings of the present invention can be readily understood by considering the following detailed description in conjunction with the accompanying drawings, in which:

FIG. 1 shows a cluster tool comprising a plurality of processing cells that includes one embodiment of dual bladed robot (two dual bladed robots are shown);

FIG. 2A is a top view of one embodiment of dual bladed robot positioned with a first robot blade extended and a second robot blade retracted;

FIG. 2B is the dual bladed robot of FIG. 2A positioned with the first robot blade retracted and the second robot blade extended;

FIG. 2C shows a side cross sectional view of one embodiment of the dual bladed robot of FIG. 2A;

FIG. 2D is an expanded cross-sectional view of one embodiment of dual bladed robot taken through sectional lines 2D in FIG. 2B;

FIG. 3, comprising FIGS. 3A to 3S, shows a progression of robot motions of the dual bladed robot shown in FIGS. 2A, in which a plurality of substrates are displaced relative to a single process cell in a cluster tool;

FIG. 4 shows an alternate embodiment of cluster tool/dual bladed robot configuration using the dual bladed robot of FIG. 2A, in which a plurality of substrates are simultaneously inserted in a cluster tool having plurality of process cells P1 and P2;

FIG. 5, comprising FIGS. 5A to 5E, shows a progression of robot motions of the dual bladed robot of FIG. 4 in which a plurality of robot blades are simultaneously inserted into, and removed from, process cells P1 and P2 in a cluster tool;

FIG. 6 shows yet another alternate embodiment of cluster tool/dual bladed robot configuration using the dual bladed robot of FIG. 2A in which a plurality of substrates are simultaneously inserted in a plurality of process cells P3 and P4 that have offset openings from a robot hub of the dual bladed robot;

FIG. 7, comprising FIGS. 7A to 7H, shows a progression of robot motion of the dual bladed robot inserted in the cluster tool of FIG. 6 in which a plurality of substrates are simultaneously displaced relative to a plurality of process cells;

FIG. 8 shows a side view of an alternate cross-sectional embodiment of dual bladed robot from that shown in FIG. 2C;

FIG. 9 shows a side view of yet another embodiment of dual bladed robot;

FIG. 10 shows a side view of still another embodiment of dual bladed robot;

FIG. 11 shows one embodiment of method performed by the controller of FIG. 2 in providing robot motions; and

FIG. 12 comprising FIGS. 12A to 12H, shows a progression of robot motion to be performed by the embodiment of dual bladed robot shown in FIG. 10.

To facilitate understanding, identical reference numerals have been used, where possible, to designate identical elements that are common to the figures.

### DETAILED DESCRIPTION

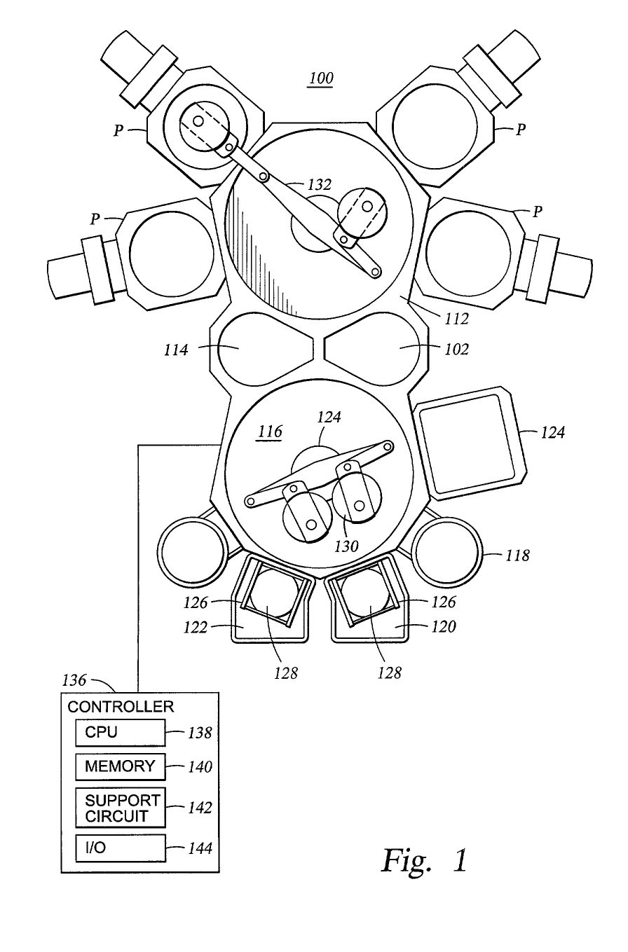

After considering the following description, those skilled in the art will clearly realize that the teachings of my invention can be readily utilized in robot systems used in cluster tools or other applications of robot systems. FIG. 1 depicts a schematic diagram of one embodiment of cluster tool 100 that can be configured with either single, dual, or multiple blade robots to transfer substrates between cells. The configuration and the operation of a typical embodiment of cluster tool are described. The configuration and operation of different embodiments of multiple bladed robots that can be utilized in the cluster tool are then described.

1. Cluster Tool—Robot Structure

The cluster tool 100 contains, for example, four process cells P, a transfer cell 112, a preclean cell 114, a buffer cell 116, a substrate-orienter/degas cell 118, a cooldown cell 102, a metrology cell 123 and a pair of load lock cells 120 and 122. Each process cell can be configured to provide a different stage or phase of semiconductor substrate processing. The buffer cell 116 is centrally located and in fluid communication between the transfer cell 112, the plurality of load locks 120 and 122 the metrology cell 123, the substrate orienter/degas cell 118, the preclean cell 114, and the cooldown cell 102. The transfer cell 112 is in fluid communication with a plurality of process cells P, the preclean cell 114, and the cool-down cell 102.

The buffer cell 116 contains a first robotic transfer mechanism 123 to effectuate substrate transfer amongst the cells surrounding the buffer cell 116. The substrates 128 prior to, and following being transferred by the first robot transfer mechanism 123 are typically contained in a cassette 126. One cassette 126 is mounted within each one of the load lock cells 120 or 122. The first robot transport mechanism 123 transports the substrates 128, one at a time, from the cassette 126 directly to any of the cells 118, 102, 120, 122, 123, or 114. As an exemplary robot motion, during processing in a cluster tool, a substrate is first placed in the substrate orienter/degas cell 118 then moved to the preclean cell 114. The cooldown cell 102 is generally not used until after the substrate is processed within the process cells P. The substrate may be inserted in the metrology cell 123 prior to, or following, processing in process cell P to measure or inspect the electric or physical characteristics of a substrate. Individual substrates are carried upon a substrate transport blade 130 that is located at the distal end of the first robotic mechanism 123.

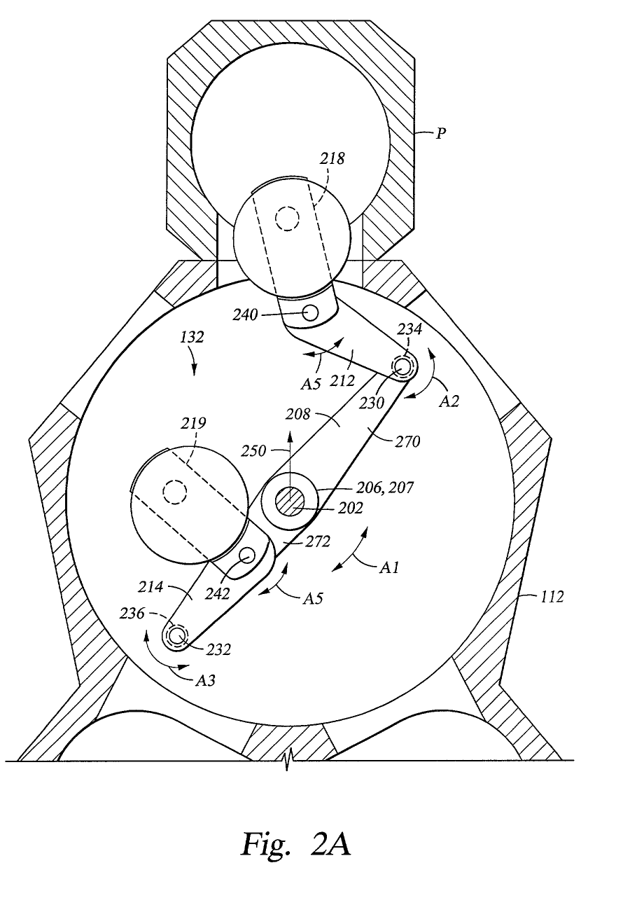

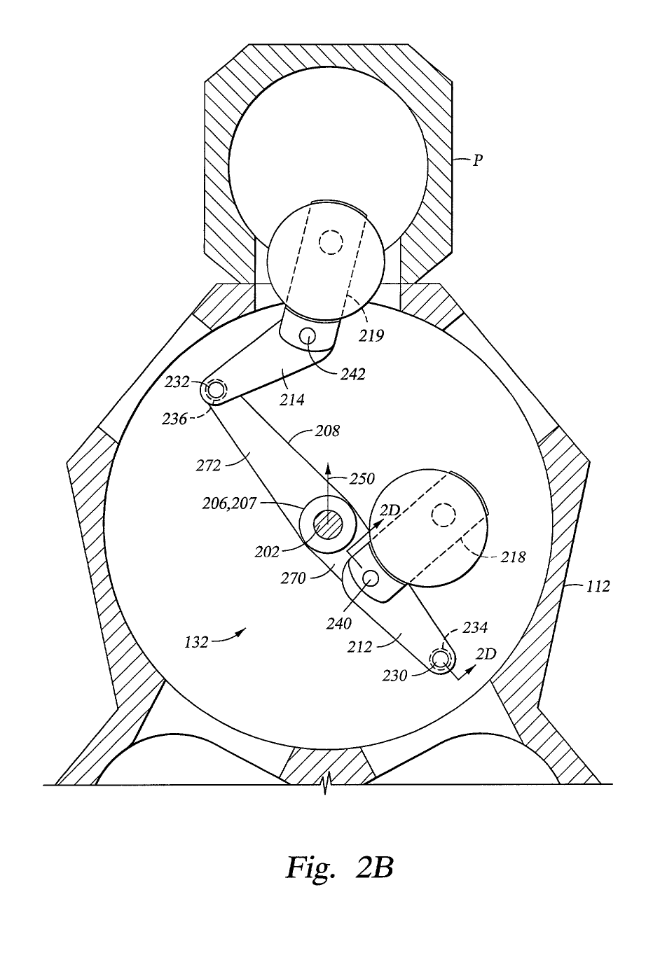

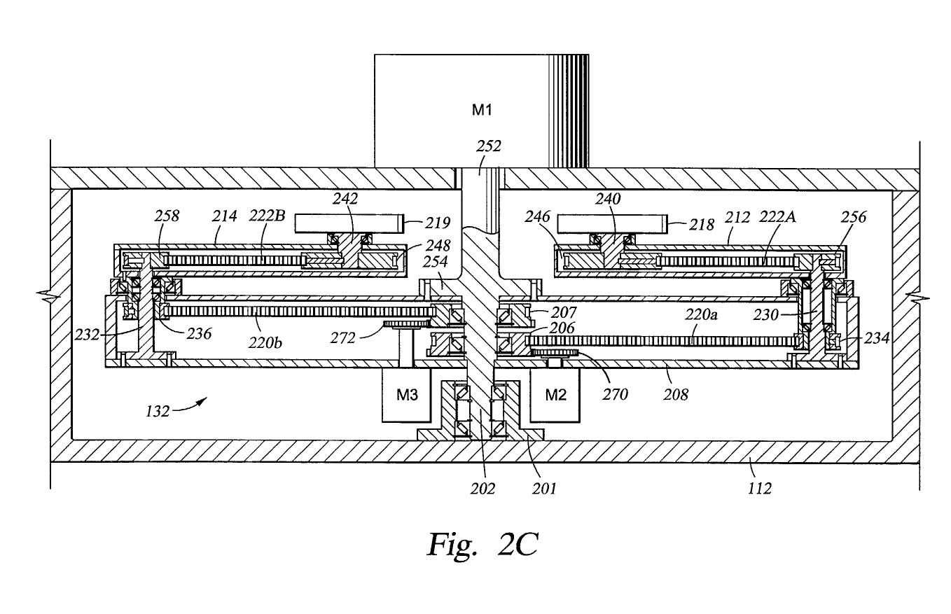

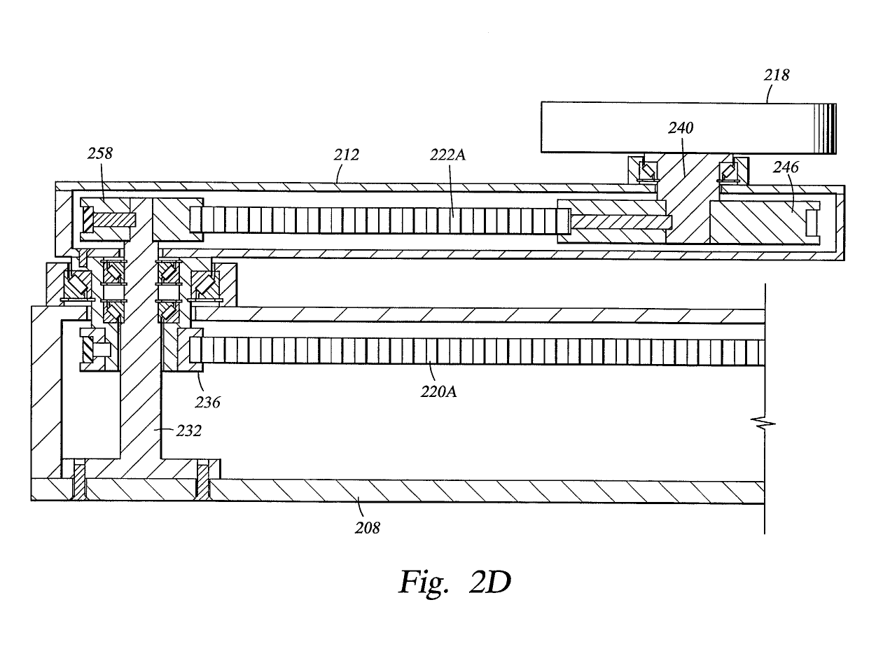

A robot transport mechanism 132 transports one, or a pair of, substrates(s) between different ones of the process cells P. The embodiment of robot transport mechanism 132 in FIG. 1 is similar to the first robotic transfer mechanism 124. Different embodiments of the robot transport mechanism 132 are shown in, and described relative to, FIGS. 2A to 2D, 8, 9, and 10. The robot transport mechanism 132 can drop off or pick up substrates relative to the transfer cell 112 and/or the preclean cell 114. Alternatively, the robot transport mechanism 132 can drop off or pick up substrates relative to cells 102 and/or 114.

A controller 136 controls the transport operation of both the robot transfer mechanisms 123, 132 and the operation of the cluster tool 100. The controller 136 controls the processing, inspecting, substrate transfer, and other processes performed by the cluster tool 100. The controller 136 contains a processor 138 (CPU), a memory 140 for storing the control routines, and support circuits 142, such as power supplies, clock circuits, cache, and the like. The controller 136 also contains input/output peripherals 144 such as a keyboard, mouse, and display. In one embodiment, the controller 136 is a general-purpose computer that is programmed to perform the sequencing and scheduling of the substrate processing operations and the robot transfer of substrates. It is contemplated that some of the process steps described herein as software processes may also be implemented with hardware (e.g., as circuitry) that cooperates to perform various process steps. The processes performed by the controller 136 can also be implemented as application specific integrated circuit (ASIC) or discrete circuit components.

The structure and operation of process cells P are uniquely configured specifically for the process to be performed within that process cell. For example, the process cells may perform physical vapor deposition, chemical vapor deposition, etching, or cleaning electroplating, or other deposition processes. Such process cells are process specific and are generally known in each specific processing art. As such, no specific process will be described in great detail herein.

FIGS. 2A and 2B show two top views in different positions, and FIG. 2C shows a side view, of one embodiment of the robot transport mechanism 132 as shown in FIG. 1. The robot transfer mechanism 132 positioned in the transfer cell 112 may (or may not) be structurally and functionally identical to the first robotic transfer mechanism 123 contained in the buffer cell 116. FIGS. 2D are cross sectional views taken through section lines 2D of FIG. 2B to show certain components in the robot transfer mechanism. During this description, FIGS. 2A to 2D should be viewed and considered together to consider the overall structure and operation of the robot transport mechanism 132.

The embodiment of robot transport mechanism 132 shown in FIG. 2C comprises a robot hub 202, an axle 252, a first hub pulley 206, a second hub pulley 207, a main robot linkage 208 having a first end 270 and a second end 272 distally positioned about the robot hub 202, a hub motor M1, a first extension motor M2, a second extension motor M3, a first extension hub 230, a first extension axle 231, a second extension hub 232, a second extension axle 233, a first extension pulley 234, a second extension pulley 236, a first extension arm 212, a second extension arm 214, a first robot blade 218, a second robot blade 219, a first robot blade hub 240, a second robot blade hub 242, a first blade pulley 246, a second blade pulley 248, a first extension/blade pulley 256, a second extension/blade pulley 258, and a plurality of belts 220a, 220b, 222a, and 222b that extend between different ones of the pulleys.

The term “robot blade” is intended to describe any end effector, robot blade, or similarly known structure that is configured to hold a substrate or a plurality of substrates. Each robot blades 218, 219 may be configured in a side-to-side configuration, or as one above the other configuration, to provide for the sequential insertion of a plurality of substrates into one, or more, process cells, or to provide for the simultaneous insertion of a plurality of substrates into a plurality of process cells. The term “substrate” refers to any substrate, wafer, or display such as liquid crystal display (LCD) that is being processed.

The embodiment of hub motor M1 shown in FIG. 2C controllably rotates axle 252 about a substantially vertical axis. The axle 252 is attached, e.g. by fastener, rivet, adhesive, welds, key, or the like to the robot hub 202 in a manner that the hub motor M1 provides controllable rotation, within a substantially horizontal plane, of the main robot linkage 208 about robot hub 202 as indicated in FIG. 2A by arrow A1. The hub motor M1 (as well as the extension motors M2 and M3) is preferably a stepper or electromechanical motor, but is any device that can be actuated through prescribed incremental angles may be used. The incremental angles at which the hub motor M1 rotate the main robot linkage 208 depend on the arrangement, and angle of the cells in the cluster tool about the robot transport mechanism 132.

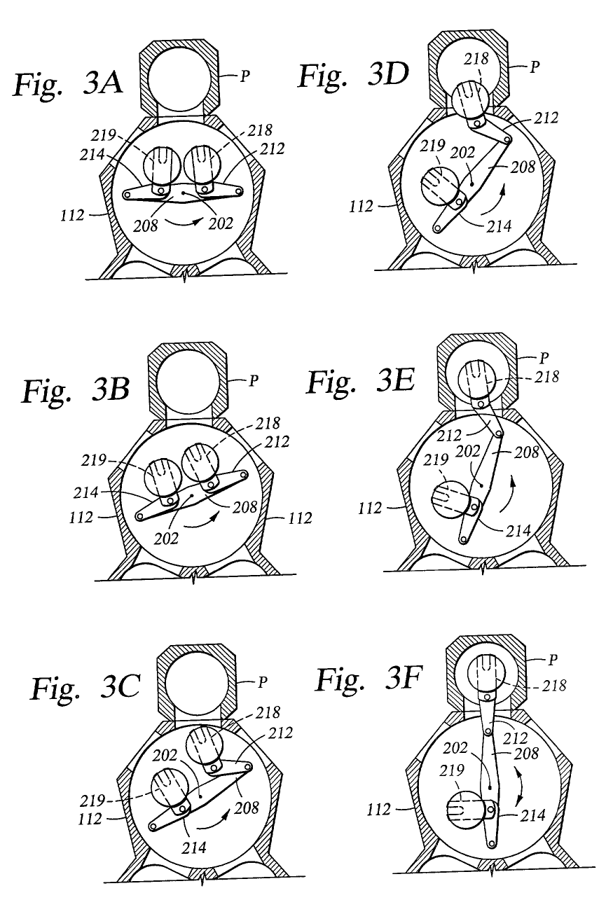

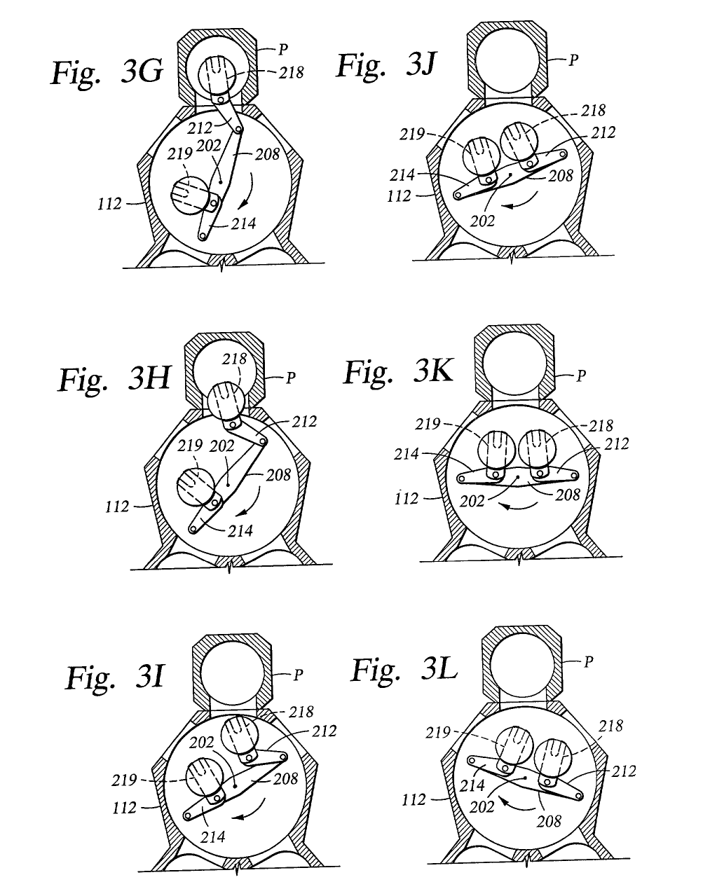

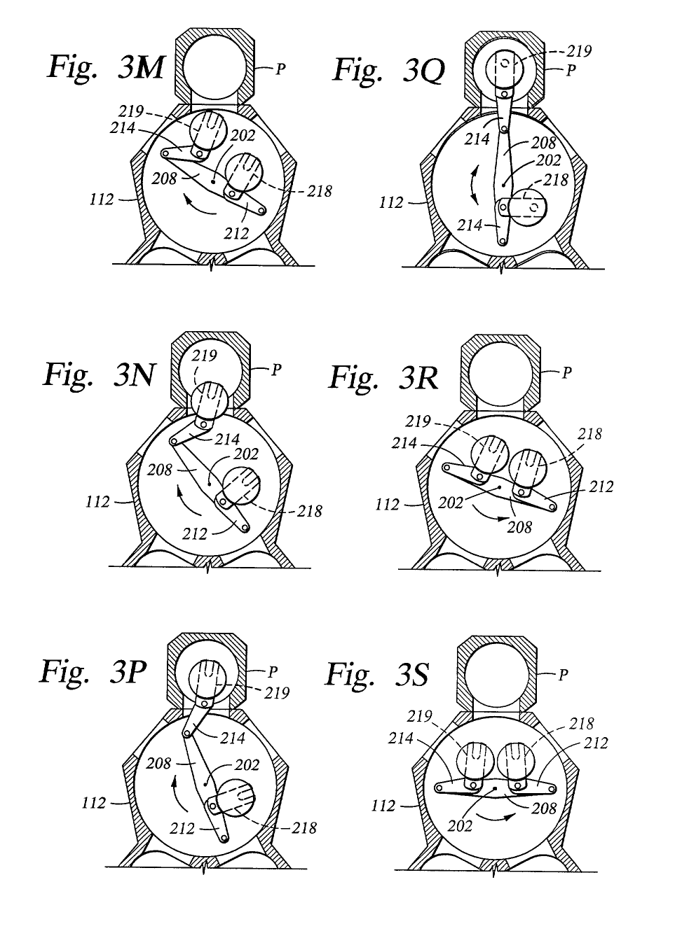

As the hub motor M1 rotates the main robot linkage 208 so the latter is aligned with a cell, one of the extension arms 212, 214, and its associated robot blade 218, 219 are simultaneously displaced at a prescribed angle relative to one of the process cells P. For example, the hub motor M1 can be configured to incrementally rotate the main robot linkage 208 (and the respective extension arms 212, 214 plus the respective robot blades 218, 219) of the robot transport mechanism 132 to a first aligned position as shown in FIG. 3F relative to a single process cell P. In the first aligned position, the first extension arm 212 and the first robot blade 218 are extended to insert the first robot blade in process cell P. In the second aligned position as shown in FIG. 3Q, the second extension arm 214 and the second robot blade 219 are extended so the second robot blade is inserted in process cell P. The robot hub 202 may preferably of the type to which polar robots are typically fixedly mounted, though any type of suitable robot hub that can rotatably index the main robot linkage 208 is within the intended scope of the present invention.

The first extension arm 212 and the second extension arm 214 are attached to the main robot linkage 208 at opposite lateral ends. The first extension axle 231 is non-rotatably affixed to the main robot linkage 208 by bolt, key, adhesive, weld or other such fastener. The first extension hub 230 is fixedly mounted to the first extension arm 212 at the first end 270 of the main robot linkage. Rotation of the first extension hub 230 results in rotation of the first extension arm relative to the main robot linkage 208 within a substantially horizontal plane. The first hub pulley 206 concentrically mounted about the axle 252 by bearings. The first extension motor M2 rotatably drives the first hub pulley 206 by a fraction drive or other known system. The belt 220a extends between, and transfers rotational motive force between, the first hub pulley 206 and the first extension pulley 234. The first extension pulley 234 is fixedly mounted relative to the first extension hub 230 to transfer rotation.

The second extension hub 232 is coaxial with the second extension axle 233 and 15 fixedly mounted to the second extension arm 214 at the second end 272 of the main robot linkage 208. Rotation of the second extension hub 232 thus results in rotation of the second extension arm 214 within a substantially horizontal plane relative to the main robot linkage 208. The second hub pulley 207 is concentrically rotatably mounted about the axle 252 by bearings. The motor M3 rotatably drives the second hub pulley 207. The belt 220b extends between, and transmits rotational motive force between, the second hub pulley 207 and the second extension pulley 236. The second extension pulley 236 is fixedly mounted relative to the second extension hub 232 to transfer rotation therebetween.

This configuration permits the first extension arm to rotate, as indicated by arrow A2 in FIG. 2A. about the first end 270 of the main robot linkage 208 between a variety of different angular positions two of which are shown in FIGS. 2A and 2B. Similarly, the second extension arm 214 can rotate, as indicated by arrow A3 in FIG. 2A, about the second end 272 of the main robot linkage 208 between a variety of different angular positions. The second end 272 of the main robot linkage is located on an opposite lateral side of the robot hub 202 from the first end 270.

The first robot blade 218 is fixedly mounted to the first robot blade hub 240. The first robot blade hub 240 is mounted to be able to rotate in the horizontal plane as indicated by arrow A4 in FIG. 2A, at the distal end of the first extension arm 212 from the first extension hub 230. The second robot blade 219 is fixedly mounted to the second robot blade hub 242. The second robot blade hub 242 is mounted to be able to rotate in the horizontal plane as indicated by arrow A5 in FIG. 2A, at the distal end of the second extension arm 214 from the second extension hub 232.

The first/extension/blade pulley 256 is rigidly affixed to first extension axle 231 by a key, bolt, adhesive, weld or other equivalent fastener. The first blade pulley 246 is rigidly affixed to the first robot blade of 240 by a key, bolt, adhesive, weld or other equivalent fastener. The belt 220a extends between, and transfers rotational motion between, the first extension/blade pulley 256 and the first blade pulley 246. As such, any relative rotation between the first extension axle 231 and the first extension hub 230 will result in rotation of the first extension/blade pulley 256, rotation of the first blade pulley 246, and rotation of the first robot blade 218 relative to the first extension arm 212.

The second extension/blade pulley 258 is rigidly affixed to second extension axle 232 by a key, bolt, adhesive, weld, or other similar fastener. The second blade pulley 248 is rigidly affixed to the second robot blade hub 242 by a key, bolt, adhesive, weld, or other similar fastener. The belt 220b extends between, and transfers rotational motion between, the second extension/blade pulley 258 and the second blade pulley 248. As such, any relative rotation between the second extension axle 232 and the second extension hub 232 will result in rotation of the second extension/blade pulley 258, rotation of the second blade pulley 248, and rotation of the second robot blade 219 relative to the second extension arm 214.

The robot transport mechanism 136 shown in the embodiment of FIG. 2C provides for the simultaneous rotational extension or retraction of both the first robot blade 218 and the first robot arm 212 upon actuation of the first extension motor M2. The embodiment of robot transport mechanism also provides for simultaneous rotational extension or retraction of both the second robot arm 214 upon actuation of the second extension motor M3.

This configuration permits the second extension arm 214 and the second robot blade 219 to rotate about the distal end of the second extension arm 214 in an independent action from the rotation of the first robot blade 218 about the distal end of the first extension arm 214 and the first extension arm 212. This relative displacement between the robot blades 218 and 219 is illustrated by comparing the relative positions of the robot blades and extension arms 212 and 214 in the positions shown in FIGS. 2A and 2B and in FIGS. 3A to 3S.

In one embodiment of robot transport mechanism 132, aligning the main robot linkage 208 with a particular process cell position the main robot linkage 208 allows extension of one of the extension arm/robot blade combinations to insert one of the robot blade to a process cell.

When the main robot linkage 208 is rotated one position, the first robot arm 212 and the first robot blade 218 can be extended to displace the first robot blade 218 into process cell P. When the main robot linkage 208 is rotated to another position, extension of the second robot arm 214 and the second robot blade 219 will displace the second robot blade 219 into process cell P. When the main robot linkage 208 is in the position shown in FIG. 3F, the second robot blade 219 is too distant from the process cell P to be inserted into the process cell regardless of the angular orientation of the second robot arm 214 and/or the second robot blade 219. When the main robot linkage 208 is in its position shown in FIG. 3Q, the first robot blade 218 is to distant from the process cell P to be inserted therein regardless of the angular orientation of the first robot arm 212 and/or the first robot blade 218.

For example, in FIG. 2A, the robot transport mechanism 132 is configured so the first robot blade 218 is being inserted into, while the second robot blade 219 is remote from the process cell P. By comparison, in FIG. 2B, the second robot blade 219 is being inserted into the process cell P, while the first robot blade 218 is remote from the process cell P.

As shown in the embodiment of robot transport mechanism 136 shown in FIG. 2C, the first hub pulley 206 and the second hub pulley 207 are both concentric with the robot hub 202 and are mounted to permit relative rotation between each of the hub pulleys 206, 207, and the robot hub 202. The first hub pulley 206 is independently rotatably mounted to the axle 252, and is therefore free to rotate relative to the second hub pulley 207 (and vice versa). The first extension motor M2 can controllably rotatably drive the first hub pulley 206 within a substantially horizontal plane as shown in FIGS. 2A and 2B via a first pulley drive 270 using a friction-drive, a gearing mechanism, or other such drives. The second extension motor M3 can controllably rotatably drive the second hub pulley 207, via a second pulley drive 272 using a friction-drive, a gearing mechanism, or other such drives, within a substantially horizontal plane shown in FIGS. 2A and 2B. Rotation of the first hub pulley 206 is translated to the first extension pulley 234 by belt 220a. Rotation of the second hub pulley 207 is translated to the second extension pulley 236 by belt 220b Rotation of the first extension/blade pulley 256 is translated to the first blade pulley 246 240 by belt 222a. Rotation in the second extension blade/pulley 258 is translated to the second blade pulley 248 by belt 222b. Though belts 220a, 220b, 222a, and 222b are shown in the embodiment shown in FIGS. 2A to 2E, it is envisioned that chains, belts, gears, or any suitable known type of rotary motion translating device may be utilized. The relative dimensions of the pulleys or gears are selected to provide the desired robot motions.

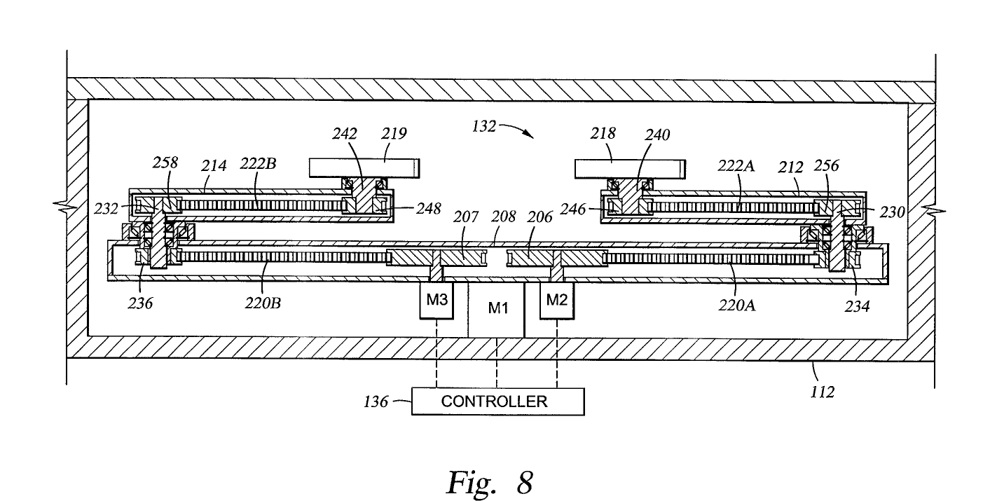

Alternate embodiments of robot transfer mechanism 132 are shown in FIGS. 8, 9, and 10. In FIG. 8, the vertical axis that each of the motors M2 and M3 act through are offset from the vertical axis of the primary motor M1 (the vertical axis of the primary motor M1 coincides with axle 252). Such an offset positioning of the motors M2 and M3 from the motor M1 wherein motor M1 rotates the main robot linkage 208, about a substantially vertically axis, may provide for a simplified construction for certain designs. Additionally, in the embodiment shown in FIG. 8, the motor M1 is disposed beneath the main robot linkage 208. Whether each of the motors M1, M2, and/or M3 are positioned above or below the main robot linkage 208 is a design choice. As such, the following descriptions that describe the operation of the embodiment of robot transfer mechanism 132 shown in FIG. 2C can also be accomplished by the embodiment of robot transfer mechanism shown in FIG. 8. The motors M2 and M3 in the embodiment of robot transfer mechanism 132 shown in FIG. 8 can be mounted in the main robot linkage 208 as far laterally as desired from the robot hub 202. In the embodiment of robot transfer mechanism 132 shown in FIGS. 2C and 8, the circumference of the first hub pulley 206, the first extension pulley 234, the first extension/blade pulley 256, and the first blade pulley 246 can be selected to provide a desired relative angular linkage travel between to the first extension arm 212 and the first robot blade 218. Additionally, a second hub pulley 207, the second extension hub 232, the second extension/blade pulley 258, and the second blade pulley 248 can be selected to provide a desired relative angular linkage travel between of the second extension arm 214 and a second robot blade 242. For example, if it is desired to provide a robot motion to the first robot blade 218 and the first extension arm 212 wherein any rotation of the first extension arm 212 about the first extension hub 230 will be countered by a rotation in the opposed direction (clockwise or counter-clockwise) of the first robot blade 218 about the blade hub 240. In addition, assume that it is desired to provide an angular rotation rate to the first robot blade 218 that has an amplitude equal to half the angular rotation rate of the first extension arm 212. This may be accomplished by making the circumference of the first hub pulley 206 equal to twice the circumference of the first extension pulley 234, and additionally making the circumference of the first extension/blade pulley 256 half of the circumference of the first blade pulley 246. Similar angular rotational constraints to the second extension arm 214 and the second robot blade 219 may also be provided by controlling the diameter of the second set of pulleys 207, 236, 258, and 248 in a similar maimer as describe relative to the first set of hub pulleys 206, 234, 256, and 246. The diameters of all of the pulleys 206, 234, 256, 246, 207, 236, 258, and 248 must be sufficient relative to the respective belts 220a, 222a, 220b, 222b to provide their respective rotational motions. For example, the circumference of the first extension pulley 234 will not be selected to so that the diameter that is too small for the belt 220a to effectively interoperate with.

While the pulleys and belts are utilized in the embodiment shown in FIGS. 2c and 8 to provide the respective extension arm 212, 214, and robot blade 218, 219 motions, is also envisioned that gearing mechanism and other suitable rotary motion transfer devices may also be utilized. For example, the first hub pulley 206, the first extension pulley 234, and the belt 220a combination may be replaced by a pair of intermeshing gears, wherein the first gear is driven by the motor M2, and the second gear is rotatably affixed to the robot hub 230 to drive the first extension arm 212. However, in the embodiment of robot transfer mechanism 132 shown in FIGS. 2C and 8, the direction of rotation of the first hub pulley 206 in the first extension pulley 234 are the same because of the belt 220a extends around both pulleys 206 and 234 an embodiment including engaging gears, the rotation of the inner meshing gears would be opposed. For example, a first driver gear rotating clockwise as viewed from above will drive a second driven gear counter-clockwise. As such, if the pulley system shown in the embodiments in FIGS. 2C and 8 are replaced by an intermeshing gear mechanism, the direction of rotation of the intermeshing gears would have to be modified accordingly.

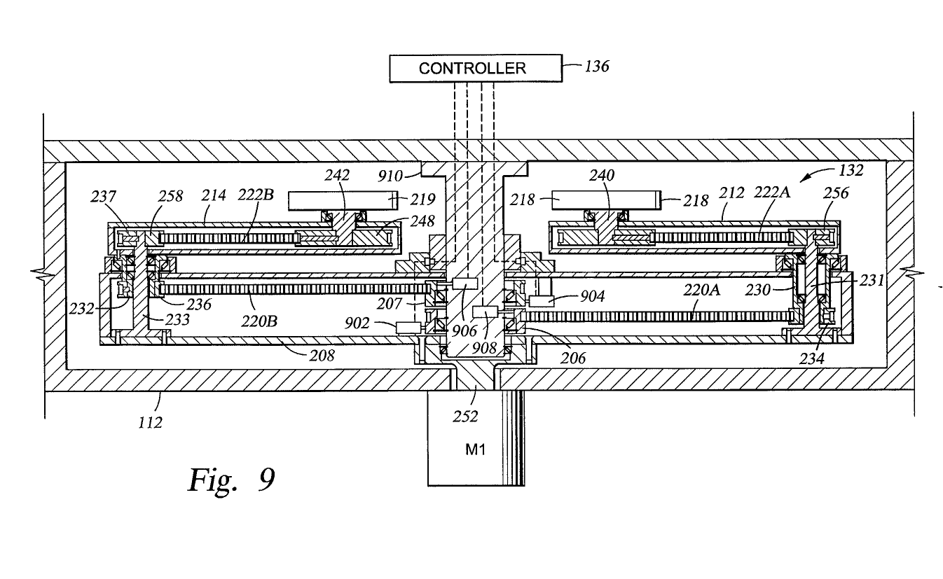

FIG. 9 shows an embodiment of robot transfer mechanism 132. The robot transfer mechanism 132 utilizes a single motor M1 and a plurality of selective lock mechanisms 902, 904, 906, 908. The interaction between the motor M1 and the selective lock mechanisms 902, 904, 906, 908 interact to provide controllable relative motion between each of the transfer cell 112, the main robot linkage 208, the first and second extension arms 212, 214, and the first and second robot blades 218, 219. Each of the selected lock mechanisms 902, 904, 906, 908 may be provided as, e.g., solenoid lock mechanism, electromechanical lock mechanism, or other similar lock mechanism.

A static mount 910 is provided within the transfer cell 112, and the axle 252 is configured to rotate around the static mount 910. The axle 252 is rotatably driven by the motor M1. The axle fits in an opening in the static mount 910 such that the axle can rotate about the static mount. The axle 252 is attached to the main robot linkage 208 by bolts, screws, welds, adhesives, or other similar securement or attachment devices. A controller 136 controls the actuation of each of the selective lock mechanisms 902, 904, 906, and 908. The first hub pulley 206 and the second hub pulley 207 are each independently rotatably mounted about the static mount 910. The motion of the first hub pulley 206 is controlled by the actuation of selective lock mechanisms 902 and 908. The motion of the second hub pulley 207 is controlled by the actuation of selective block mechanisms 904 and 906.

Actuation of the selective lock mechanism 902 results in the first hub pulley 206 being rigidly affixed, and thereby rotating uniformly with, the main robot linkage 208. Actuation of the selective lock mechanism 908 acts to lock the first hub pulley to the static mount, and thereby limit relative motion between the first hub pulley and the static mount 910. Selective lock mechanisms 902 and 908 are individually controlled by the controller 136 be alternatively actuated, i.e., both selective lock mechanisms 902 and 908 cannot be actuated simultaneously.

When the selective lock mechanism 902 is actuated, the first hub pulley 206 is affixed to the main robot linkage 208. Due to the first hub pulley 206 being secured to the main robot linkage 208, the belt 220A remains stationary relative to the main robot linkage 208. Thus, while 208 may be configured to rotate within the transfer cell, actuation of selective lock mechanism 902 will act to lock the first robot pulley 206, the belt 220A, and the first extension pulley 234 within, and relative to, the main robot linkage 208.

Limiting the relative rotation of extension pulley 234 by actuation of the selective lock mechanism 902 also limits any relative rotation of the extension hub 230 and the first extension arm 212 (that are both connected to the first hub pulley) relative to the main robot linkage. As such, actuation of the selective lock mechanism 902 results in relative locking of the first hub pulley 206, belt 220A, first extension pulley 234, first extension hub 230, first extension/blade pulley 256, first extension axle 231, and the first extension arm 212. As such, all of these members rotate as a single unit as the selective lock mechanism 902 is locked.

Since the actuation of the selective lock mechanism 902 limits relative displacement of the first extension/blade pulley 256 relative to the first extension arm 212, the first extension/blade pulley 256, belt 222A, first blade pulley 246, first blade hub 240, and the first robot blade 218 will remain stationary relative to, and displace as a unit with relative to, the first extension arm 212. Therefore, actuation of the selective lock mechanism 902 acts to relatively lock the main robot linkage 208, the first extension arm 212, and the first robot blade 214 as a unit relative to each other. This relative locking occurs even if the main robot linkage 208 rotates about the robot hub.

Actuation of the selective lock mechanism 908 acts to lock the position of the first hub pulley 206 relative to the static mount 910. The static mount 910 is rigidly mounted to the transfer cell 112. Therefore actuating the selective lock mechanism 908 acts to lock the first hub pulley 206 in place within the transfer cell 112. Regardless of the locking of the selective lock mechanism 908 locking the first hub pulley 206 relative to the static mount, motor M1 can rotate the main robot linkage 208 around the axle 252.

Therefore, if the motor M1 rotates the axle 252 to rotate the main robot linkage 208, actuation of the stationary selective lock mechanism 206 results in a counter rotation of the first hub pulley 206 relative to the main robot linkage 208. The first robot pulley 206 may thus be viewed as counter rotating relative to the main robot linkage 208 if the selective lock mechanism 208 is actuated and the main robot linkage is rotating.

Such relative counter rotation of the stationary first hub pulley 206 within the main robot linkage results in transfer of motion via belt 220A to produce a rotation of the first extension pulley 234. Such rotation of the first extension pulley 234 is transferred via the first extension hub 230 to the first extension arm 212 since the latter three members are all rigidly affixed. Therefore, the first extension pulley 234, the first extension arm 230, in the first extension arm 212 act to rotate around the first extension axle 231.

The first extension axle 231 is fixed with relative to the main robot linkage 208. As such any rotation to the first extension pulley 234 results in rotation of the first extension arm 212. This rotation of the first extension arm may be viewed as counter rotation of the first extension pulley and the first extension axle 231 relative to the first extension arm 212. Counter rotation of the first extension pulley 234 relative to the first extension arm 212 is transferred to the first extension/blade pulley 252. Relative rotation of the first extension/blade pulley within the first extension arm 212 is translated via belt 220A to the first blade pulley 246. The first blade pulley 246 is rigidly connected to both the first blade mount 240 and the first robot blade 218. Therefore, producing a rotation of the first extension pulley 234 results in a rotation in a similar direction of the, e.g. clockwise, of the first extension arm 212 about the first extension axle 231. Such rotation also results in an opposite direction, e.g. counter-clockwise, of the first robot blade 218 relative to the first blade mount 240.

Actuation of the selective lock mechanism 904 results in the second hub pulley 207 being rigidly affixed, and thereby rotating uniformly with, the main robot linkage 208. Actuation of the selective lock mechanism 906 acts to lock the second hub pulley to the static mount, and thereby limit relative motion between the second hub pulley and the static mount 910. Selective lock mechanisms 904 and 906 are individually controlled by the controller 136 to be alternatively actuated, i.e., both selective lock mechanisms 904 and 906 cannot be actuated simultaneously.

When the selective lock mechanism 904 is actuated, the second hub pulley 207 is affixed to the main robot linkage 208. Due to the second hub pulley 207 being secured to the main robot linkage 208, the belt 220b remains stationary relative to the main robot linkage 208. Thus, while 208 may be configured to rotate within the transfer cell, actuation of selective lock mechanism 904 will act to lock the second robot pulley 207, the belt 220b, and the second extension pulley 236 within, and relative to, the main robot linkage 208.

Limiting the relative rotation of the second extension pulley 236 by actuation of the selective lock mechanism 904 also limits any relative rotation of the extension hub 232 and the second extension arm 214 (that are both connected to the second hub pulley) relative to the main robot linkage. As such, actuation of the selective lock mechanism 904 results in relative locking of the second hub pulley 207, belt 220b, second extension pulley 236, second extension hub 232, second extension/blade pulley 258, second extension axle 233, and the second extension arm 214. As such, all of these members rotate as a single unit as the selective lock mechanism 904 is locked.

Since the actuation of the selective lock mechanism 904 limits relative displacement of the second extension/blade pulley 258 relative to the second extension arm 214, the second extension/blade pulley 258, belt 222B, second blade pulley 248, second blade hub 242, and the second robot blade 219 will remain stationary relative to, and displace as a unit with relative to, the second extension arm 214. Therefore, actuation of the selective lock mechanism 904 acts to relatively lock the main robot linkage 208, the second extension arm 214, and the second robot blade 214 as a unit relative to each other. This relative locking occurs even if the main robot linkage 208 rotates about the robot hub.

Actuation of the selective lock mechanism 906 acts to lock the position of the second hub pulley 207 relative to the static mount 910. The static mount 910 is rigidly mounted to the transfer cell 112. Therefore actuating the selective lock mechanism 906 acts to lock the second hub pulley 207 in place within the transfer cell 112. Regardless of the locking of the selective lock mechanism 906 locking the second hub pulley 207 relative to the static mount, motor M1 can rotate the main robot linkage 208 around the axle 252.

Therefore, the motor M1 rotating the axle 252 to rotate the main robot linkage 208 relative to the transfer cell may also be viewed as a counter rotation of the second hub pulley 207 relative to the main robot linkage 208 caused by actuation of the stationary selective lock mechanism 207. The second robot pulley 207 may thus be viewed as counter rotating relative to the main robot linkage 208 if the selective lock mechanism 208 is actuated and the main robot linkage is rotating.

Such relative counter rotation of the stationary second hub pulley 207 within the main robot linkage results in transfer of motion via belt 220b to produce a rotation of the second extension pulley 236. Such rotation of the second extension pulley 236 is transferred via the second extension hub 232 to the second extension arm 214 since the latter three members are all rigidly affixed. Therefore, the second extension pulley 236, the second extension arm 232, in the second extension arm 214 act to rotate around the second extension axle 233.

The second extension axle 233 is fixed with relative to the main robot linkage 208. As such any rotation to the second extension pulley 236 results in rotation of the second extension arm 214. This rotation of the second extension arm may be viewed as counter rotation of the second extension pulley and the second extension axle 233 relative to the second extension arm 214. Counter rotation of the second extension pulley 236 relative to the second extension arm 214 is transferred to the second extension/blade pulley 252. Relative rotation of the second extension/blade pulley within the second extension arm 214 is translated via belt 220b to the second blade pulley 248. The second blade pulley 248 is rigidly connected to both the second blade mount 242 and the second robot blade 219. Therefore, producing a rotation of the second extension pulley 236 results in a rotation in a similar direction, e.g. clockwise, of the second extension arm 214 about the second extension axle 233. Such rotation of the second extension pulley also results in an opposite direction, e.g. counter-clockwise, of the second robot blade 219 relative to the second blade mount 242.

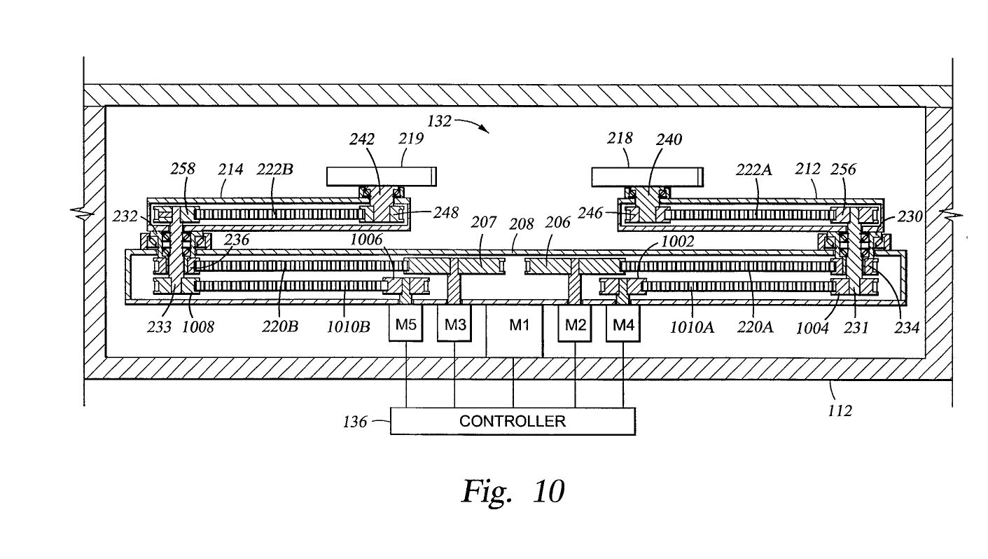

An alternate embodiment of robot transfer mechanism 132 from that shown in FIGS. 2C or 9 is shown in FIG. 10. The embodiment of robot transfer mechanism in FIG. 10 additionally includes a plurality of robot blade drive motors M4 and M5 in addition to the motors M1, M2, and M3 that are present in the embodiment of robot transfer mechanism 132 shown in FIGS. 2C and 8. Additionally, the embodiment of a robot transfer mechanism 132 shown in FIG. 10 includes pulleys 1002, 1004, 1006, and 1008 in addition to belts 1010a and 1010b. The first drive blade pulley 1002 is mounted to the output of the robot blade drive motor M4. The second blade drive pulley 1006 is fixedly mounted to the output of the robot blade drive motor M5. The pulley 1004 is rotatably affixed to the first extension axle 231. The pulley 1008 is rotatably affixed to the second extension axle 233. The belt 1010a extends between the first blade drive pulley 1002 and the pulley 1004. The belt 1010b extends between the second robot blade drive motor M5 and the pulley 1008.

The combination of the first robot blade drive motor M4, the fist blade drive pulley 1002, the blade drive pulley 1002, the drive belt 1010a, and the pulley 1004 act to rotate the first extension axle 231, and the first extension/blade pulley 256 relative to the main robot linkage 208 when desired. During the actuation of the robot blade drive motor M4 that rotates the first extension axle 231 and the first extension/blade pulley 256, provided that motor M2 is not actuated, the first extension arm 212 does not rotate about the first extension hub 230 relative to the main robot linkage 208. As such, the first extensioniblade pulley 256 is rotating within the first extension arm 212. Such rotation of the first rotation blade pulley 256 within the first extension arm 212 acts to rotate the first blade pulley 246 via the belt 222. Such rotation of the first robot blade pulley 246 within the first extension arm 212 acts to rotate the first rotate blade hub 240, and the connected first robot blade 218, relative to the first extension arm 212. Such rotation of the first robot blade 218 about the first extension arm 212 may be considered in conjunction to the illustration of the robot transfer mechanism 132, as viewed from above in FIG. 2B.

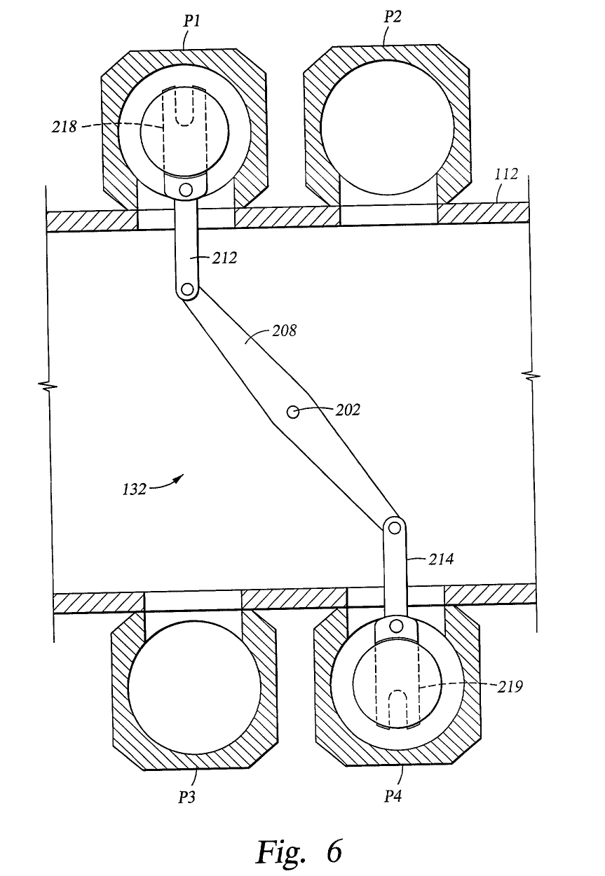

In the position of the robot transfer mechanism 132 shown in FIG. 2B, the first extension arm 212 and the first robot blade are both in their retracted positions. Additionally, the first robot blade extends generally to the right of the first robot blade hub 240. This position may be desired if the first robot blade 218 and the first extension arm 212 are to be inserted in a process cell from generally left of the opening of the process cell, wherein the main robot linkage 208 continues its rotation in a counter-clockwise direction as the first extension arm 212 and the first robot blade 218 continue to extend fully. Additionally, such a configuration may be desired to enter a process cell that has an opening that is generally offset from the robot hub 202 to the left, as shown by process cell P2 in FIG. 6, wherein the opening of the process cell P1 extends to the left of the robot hub 202.

Under these circumstances, it may be desired to rotate the first robot blade 218 about the first robot blade hub 240 by some angle, e.g. 180 degrees, while maintaining the first extension arm 212 in its retracted position. Such a rotation of the first robot blade 218 positions the first robot blade 218 into another retracted position. The second retracted position would be useful if it was desired for the robot transfer mechanism 132 insert the first robot blade 218 from the right of an opening in a process cell that is aligned of the robot hub 202. Such an extension could occur simultaneously with the counter-clockwise rotation of the main robot linkage 208, about the robot hub 202 and the extension of the first extension arm 212 and the first robot blade 218. Such actuations of the desired ones of the motors M1, M2, M3, M4, and/or M5 can be provided in series or in combination to provide the desired robot motions. A rotation of the main robot linkage 208 accompanying the extension of the first robot blade 218 and the first extension arm 212 would act to extend the first robot blade 218 into the process cell P. Such extension would also be useful to extend the first robot linkage into a process cell that has an opening that extends generally to the right of the robot hub.

In the embodiment of robot transfer mechanism shown in FIG. 10, the motors M4 and M5 can be operated simultaneous with, or independently of, motors M1, M2, and M3. As such, the motors M4 and M5 provide for independent rotation of the first robot blade 218 about the first robot blade hub 240 while the first extension arm 212 remains static relative to the main robot linkage 208.

The lengths of the first extension arm 212 and the second extension arm 214 are both selected to be slightly less than half the length of the main robot linkage 208 so one of substrates can be held by the first robot blade while a second substrate is held by the second robot blade as both robot blades are in their retracted positions. Alternatively, the first robot blade can be vertically offset in that second robot blade to limit such substrate contact.

2. Operation and Robot Motions of Robot Transport Mechanism

The following provides exemplary, but not by any means exhaustive, descriptions of the robot motions that can be provided by the embodiment of robot transfer mechanisms 132 shown in FIGS. 2C, 8, 9, 10. The wide variety of transfer cell configurations and robot motions that can be provided by the robot transfer mechanism indicates the utility of the robot transfer mechanism. Initially, the robot motions of the embodiment of robot transfer mechanism shown in FIG. 2C is described.

To position the first robot blade 218 into the process cell P, hub motor M1 initially rotates the main robot linkage 208 in a generally counter-clockwise direction about robot hub 202, a position shown in FIG. 2A. Such a counter-clockwise rotation of the main robot linkage 208 has the effect of positioning the first extension arm 212 and the first robot blade 218 closer to the opening of the process cell. Additionally, the second extension arm 214 and the second robot blade 219 are positioned remote from the process cell P.

To effect simultaneous extension of the first extension arm 212 and the first robot blade 218, the first extension motor M2 drives the first hub pulley 206 in a direction, e.g., clockwise, as viewed from above. The simultaneous extension of the first extension arm and the first robot blade, when the main robot linkage is being rotated into alignment, results in the insertion of the first robot blade into process cell P. Actuation of the first extension motor M2 rotates the first hub pulley 206 in, e.g., a clockwise direction, as viewed in FIG. 2A that additionally drives the belt 220a in a clockwise direction. The belt 220a is tensioned about the first extension pulley 234 that is rigidly coupled to both the first extension hub 230 and the first extension arm 212. Clockwise rotation of the belt 220a therefore results in a clockwise rotation of the first extension arm 212 about the first extension hub 230. The first extension/blade pulley 256 is rotationally affixed, and remains rotationally stationary relative to the main robot linkage 208 via the first extension axle 231. The first extension/blade pulley 256 therefore rotates in a generally counter-clockwise direction relative to the first extension arm 212 as the first extension arm rotates in a clockwise direction about the first extension hub 230.

Belt 222a extends around, and is tensioned to, the first extension/blade pulley 256 and the first blade pulley 246. The first blade pulley 246 is non-rotatably coupled to the first robot blade hub 218. The counter-clockwise rotation of the first extension/blade pulley 256 relative to the first extension arm 212 thus results in a counter-clockwise rotation of the belt 222a and a resultant counter-clockwise rotation of the first robot blade hub 240 and the connected first robot blade 218 about the first robot blade hub 240 relative to the first extension arm 212.

As the first extension arm 212 and the first robot blade 218 are extended closer to the process cell the second extension arm 214 and the second robot blade 219 are similarly retracted to position the second robot blade 219 more remote from the process cell in FIG. 2A. To effect such maintaining of the position of the second extension arm 214 and the second robot blade 219, the second extension motor M3 is not actuated so the first robot blade 218 and the first extension arm are maintained fixed in a retracted position relative to the main robot linkage 208.

To extend the second robot blade closer to process cell P while the first robot blade 218 remains in its retracted position. Hub motor M1 rotates the main robot linkage 208 about the robot hub 202 to position the main robot linkage into a desired pre-insertion position as shown in FIG. 2B, as viewed from above. Concurrent with a portion of the counter-clockwise rotation of the hub motor M1 as viewed from above, the second extension motor M3 rotates the second hub pulley 207 in one, e.g., counter-clockwise, direction about the robot hub 202 as viewed from above. Such counter-clockwise rotation of the second hub pulley 207 results in a counter-clockwise rotation of belt 220b. The belt 220b loops around, and is tensioned to, the second extension pulley 236 that is rigidly affixed to both the second extension hub 232 and the second extension arm 214. The counter-clockwise rotation of belt 220b thus results in a counter-clockwise rotation of the second extension arm 214 about the second extension hub 232 as viewed from above.

The second extension/blade pulley 256 is rigidly coupled to both the second extension axle 233 and the main robot linkage 208, such as by a key, bolt, weld, or other fastener to limit rotation between the main robot linkage and the second extension/blade pulley 258 in the horizontal plane. The counter-clockwise rotation of the second extension arm 214 relative to the main robot linkage 208 about the second extension hub 232 therefore results in a simultaneous resultant clockwise rotation of the second extension/blade pulley 258 relative to the second extension arm 214. Such clockwise rotation of the second extension/blade pulley 258 relative to the second extension arm 214 results in a clockwise rotation of the belt 222b. The belt 222b extends about, and is tensioned to, the second robot blade pulley 248. The second robot blade pulley is in turn rigidly coupled to both the second robot blade hub 242 and the second robot blade 219. The clockwise rotation of the belt 222b thus results in the clockwise rotation of the second robot blade 219 relative to the second extension arm 214 about the second robot blade hub 242. Concurrently with the extension of the second robot blade 219 and the second extension arm 214 closer to the process cell, the first robot blade 218 and the first extension arm 212 are maintained in their respective retracted positions as shown in FIG. 2B.

The first extension arm 212 thus can extend the first robot blade 218 into process cell P by the actuation of the first extension motor M2 as the second extension arm 214 maintains the second robot blade 219 retracted within the process cell P. The second extension arm 214 can also extend the second robot blade 219 into process cell P by actuation of the second extension motor M3 as the first extension arm 214 retracts the first robot blade 218 from the process cell P. The hub motor M1 can index the main robot linkage 208 through selected prescribed angles in the horizontal plane, in both the clockwise or the counter-clockwise directions, from its original position. This indexing is provided so that the first extension arm 212 and the first robot blade 218, or alternatively the second extension arm 214 and the second robot blade 219, can interact with the process cell at the selected prescribed incremented position.

The robot transport mechanism 132 is configured such that the robot blades 218 and 219 travel within substantially the same horizontal plane. In this manner, when the hub motor M1 is indexed, both of the robot blades 218, 219 will also index and remain closely spaced to each other. The first robot arm 212 can operate independently from the second robot arm 214. The belts 220 and 222 are of a type that can be made of steel, or kevlar impregnated urethane (this is a material particularly used for robots).

The robot transport mechanism 132 shown in the embodiments in FIGS. 2C, 8, 9 and 10, may be configured to provide a variety of substrate loading configurations. For example, FIGS. 3A to 3S shows a progression of robot motions produced by a robot transport mechanism 132 that is being utilized to load or unload one, or a plurality of, substrate(s) into a single process cell. The opening of the process cell P is aligned with the robot hub 202, so the robot transport mechanism 132 is configured so when a robot blade 218 or 219 is fully extended into a process cell P, the respective robot blade 218, 219, extension arm 212, 214, and the main robot linkage 208 are all aligned. To insert a robot blade into a process cell, initially the desired end of the main robot linkage 208 of the robot transport mechanism 132 is positioned sufficiently close to the process cell P so the desired, e.g., first end 270 of the main robot linkage 208 is closely disposed outside of the process cell. The first extension arm 212 and the first robot blade 218 are simultaneously and the first robot blade 218 are simultaneously pivoted to an extended position so the first robot blade is positioned in the process cell.

During the insertion of the second robot blade 219 into the process cell P, concurrently with maintaining the first robot blade 218 retracted from the process cell P, the main robot linkage 208 is rotated in a substantially counter clockwise direction as viewed from above. FIG. 2B shows the robot transport mechanism 132 positioned half way through the transfer of the second robot blade 219 into the process cell P. In this position, both the first robot blade 218 and the second robot blade 219 are oriented in the direction substantially parallel to the main robot linkage 208.

To fully extend a substrate held by the second robot blade into the process cell P, the main robot linkage 208 is rotated in a conduit counter clockwise direction about the robot hub 202, as viewed from above. Additionally, the second robot blade 219 and the second robot arm 214 are extended toward the process cell P. Additionally, the first robot blade 218 and the first robot arm 212 are maintained in the retracted position shown in FIG. 2C, although the first robot blade 218 and the first robot arm 212 may be maintained in their neutral positions.

Configuring the robot transport mechanism 132 so the two robot blades 218, 219 are alternatively inserted into, and retracted from, a single process cell P requires that the robot hub 202 be positioned a sufficient distance away from the process cell so the main robot linkage 208 undergoes a considerable angular rotation about the extension hub 202. The robot blades 218 and 219 can be displaced to alternately carry their respective substrates into a single process cell. As a robot blade 218 or 219 is extended toward the process cell it is desired for the robot blade to remain close to an imaginary line extending from adjacent the robot hub 202 to the center of the process cell.

The robot motions of the robot transport mechanism 132 that displace multiple substrates sequentially into the same process cell P are shown by the progression of FIG. 3, comprising FIGS. 3A to 3S. FIGS. 3A to 3F indicate the rotation of the main robot linkage 208, the first extension arm 212, and the first robot blade 218 to effect insertion of one substrate into the process cell P. FIGS. 3G to 3K display the rotation of the main robot linkage 208 the first extension arm 212 and the first robot blade 218 to their retracted position. FIGS. 3L to 3Q display the rotation of the main robot linkage 208, the second extension arm 214, and the second robot blade 219 to effect insertion of the second robot blade into the process cell P. FIGS. 3R to 3S illustrate the rotation of the main robot linkage 208 along with the simultaneous extension of the second extension arm 214 and the second robot blade 219 to displace the second robot blade 219 to its retracted position.

Describing each of the FIGS. 3A to 3K in the progression of robot motion indicated, the main robot linkage 208 is substantially perpendicular to a line running from the center of the process cell P to the robot hub 208. In this position, both robot blades 218 and 219 are directed substantially toward the process cell P. FIG. 3A may be considered to be a ready position in which either of the two substrates may be inserted into the process cell P as desired. Between FIGS. 3A and 3B, the main robot linkage 208 is rotated in a generally counter clockwise direction. During the initial phases of this counter clockwise rotation that will result in the inserting of a substrate held by the first robot blade 218 into the process cell P, the first robot blade 218 and the first extension arm 212 are maintained in a retracted position. Maintaining the first robot blade and the first extension arm in the retracted position during the initial phases of the rotation from FIG. 3A to FIG. 3B permits the substrate being held by the first robot blade 218 to be positioned closer to a line extending from the robot hub 202 to the process cell P to limit any contact between the substrate being held and the edge or any lateral portions of a process cell.

Between FIGS. 3B and 3C, the first extension motor M2 shown in FIG. 2C starts its rotation resulting in the clockwise rotation of the first extension arm 212 about the first extension hub 230 and the counter clockwise rotation of the first robot blade 218 about the first robot blade hub 240. This concurrent rotation of the main robot linkage 208, the first extension arm 212, and the first robot arm 218 is shown by the progression of FIGS. 3C to 3F. In FIG. 3F, the main robot linkage 208, the first extension arm 212, and the first robot blade 218 are all substantially aligned, and are colinear, with a line extending from the robot hub 202 to the center of the process cell P.

Presumably, when the substrate is in its position shown in FIG. 3F, the equipment within process cell P (not shown) will be configured to receive the substrate from the first robot blade 218. During the extension of the first robot blade 218 and the associated members through the progression shown in FIGS. 3A to 3F, the second extension arm 214 and the second robot blade 219 remain in their retracted positions. Maintaining the second robot blade 219 and the second extension arm 214 in their retracted positions during the inserting of the first robot blade 218 into the process cell P is significant to limit any contact of any substrate being held by the robot blade 219, or alternatively limiting any contact of the robot blade itself 219, with any lateral surfaces of the transfer cell 112.

From FIG. 3F to FIG. 3K, the directions of rotational motion of the main robot linkage 208, the first robot blade, and the first extension arm are reversed compared to the rotation motions during the progression shown in FIGS. 3A to 3F. This reversal of motion results the retraction of the first robot blade 218 from the process cell P typically following substrate processing within process cell P, or alternatively when the first robot blade is being removed from the process cell P so that the substrate being held by the first robot blade can be processed within the process cell P. From a position shown in FIGS. 3A to 3F, the main robot linkage 208 is rotated in a clockwise direction around the main robot hub 202. Concurrently with this clockwise rotation of the main robot linkage that is produced by rotation of the motor M1. The motor M2 is actuated to produce a counter-clockwise rotation of the first extension arm 212 about the first extension hub 230 that also results in a clockwise rotation of the first robot blade 218 about the first robot blade hub 240. Such a series of rotation from FIGS. 3F to 3G result in the displacement of a substrate being held by the first robot blade from the interior of the process cell P to outside the process cell. Such displacement approximates but does not exactly follow a straight line extending from the main robot hub 202 to the center of the process cell P. The relative rotational motion areas of the extension arms 212, 214 and the respective robot blades 218, 219 result in some variations from such straight-line motion. In FIG. 3J, the first robot blade 218 and the first extension arm 212 are in their retracted positions. The spacing between the first robot blade 218 and a second robot blade 219, while in a position shown in FIG. 3J, had to be sufficient so that a substrate being held by the first robot blade 218 does not contact a substrate being held by the second robot blade and vice versa (and the two robot blades also do not contact each other).

The robot blades 218, 219 in the embodiment of robot transfer mechanism shown in FIGS. 3A to 3S, are laterally spaced from the robot hub when the robot blades are in their retracted states as shown in FIG. 3A to permit multiple substrates to be simultaneously held by the robot transfer mechanism. In other robot transfer mechanism embodiments, the robot blades 218 and 219 may be vertically offset from each other to allow for the multiple substrates to be positioned one above another. In yet another embodiment, the controller 136 may limit both robot blades to be fully retracted simultaneously so the multiple substrates held by the robot blades 218, 219 would not contact.

With both the first robot blade 218 and the first extension arm 212 in their retracted positions, and a second robot blade 219 and second end effector 214 in their retracted positions, the main robot linkage 208 continues its clockwise rotation from the position shown in FIG. 3J to the position shown in FIG. 3K.

Describing each of the FIGS. 3K to 3S in the progression of robot motion indicated, the main robot linkage 208 is substantially perpendicular to a line running from the center of the process cell P to the robot hub 208. In this position, both robot blades 218 and 219 are directed substantially toward the process cell P. FIG. 3K is, similar to FIG. 3A, considered to be a ready position in which either of the two substrates may be inserted into the process cell P as desired. Between FIGS. 3K and 3L, the main robot linkage 208 is rotated in a generally clockwise direction. During the initial phases of this clockwise rotation that will result in the inserting of a substrate held by the second robot blade 219 into the process cell P, the second robot blade 219 and the second extension arm 214 are maintained in a retracted position. Maintaining the second robot blade and the second extension arm in the retracted position during the initial phases of the rotation from FIG. 3K to FIG. 3L permits the substrate being held by the second robot blade 219 to be positioned closer to a line extending from the robot hub 202 to the process cell P to limit any contact between the substrate being held and the edge and any lateral portions of a process cell.

Between FIGS. 3L and 3M, the motor M3 shown in FIG. 2C starts its rotation resulting in the counter-clockwise rotation of the second extension arm 214 about the second extension hub 232 and the clockwise rotation of the second robot blade 219 about the second robot blade hub 242. This concurrent rotation of the main robot linkage 208, the second extension arm 214, and the second robot arm 219 is shown by the through the progression of FIGS. 3M to 3Q. In FIG. 3Q, the main robot linkage 208, the second extension arm 214, and the second robot blade 219 are all substantially aligned and are co-linear with a line extending from the robot hub 202 to the center of the process cell P. Presumably, when the substrate is in its position shown in FIG. 3Q, the equipment within process cell P (not shown) will be configured to receive the substrate from the second robot blade 219.

During the extension of the second robot blade 219 and the associated members through the progression shown in FIGS. 3K to 3Q, the first extension arm 212 and the first robot blade 218 remain in their retracted positions. Maintaining the first robot blade 218 and the first extension arm 212 in their retracted positions during the inserting of the second robot blade 219 into the process cell P is significant to limit any contact of any substrate being held by the first robot blade 218, or alternatively limiting any contact of the first robot blade itself, with any lateral surfaces of the transfer cell 112.

From FIG. 3Q to FIG. 3S, the directions of rotational motion of the main robot linkage 208, the second robot blade 219, and the second extension arm 214 are reversed compared to the respective rotational motions during the progression shown in FIGS. 3A to 3F. This reversal of rotational motions results the retraction of a substrate being held by the second robot blade 219 from the process cell P that results traditionally after the substrate has been processed within process cell P, or alternatively when the second robot blade 219 is being removed from the process cell P so that the substrate being held by the second robot blade can be processed within the process cell P. From a position shown in FIGS. 3Q to 3S, the main robot linkage 208 is rotated in a counter-clockwise direction around the main robot hub 202.

Concurrently with this counter-clockwise rotation of the main robot linkage that is produced by rotation of the motor M1. The second extension motor M3 is actuated to produce a clockwise rotation of the second extension arm 214 about the second extension hub 232 in addition to a counter-clockwise rotation of the second robot blade 219 about the second robot blade hub 242. Such a series of rotation from FIGS. 3Q to 3S result in the displacement of a substrate being held by the second robot blade from the interior of the process cell P. Such displacement closely follows a straight line extending from the main robot hub 202 to the center of the process cell P. In FIG. 3J, the second robot blade 219 and the second extension arm 214 are both in their retracted positions. With both the second robot blade 219 and the second extension arm 214 in their retracted positions, and the first robot blade 218 and first end effector 212 in their retracted positions, the main robot linkage 208 continues its counter-clockwise rotation from the position shown in FIG. 3R to the position shown in FIG. 3S.

To provide the type of interrelated motions between the main robot linkage, the extension arms, and the robot blades as illustrated in FIGS. 3A to 3S is important to provide suitably sized hub pulleys 206, 207 as shown in FIG. 2C. As such, this description integrates the progression of motions produced in FIGS. 3A to 3S with the size of the pulleys and hubs shown in FIG. 2C.

Considering the progression of the extension arms 212, 214, and their respective robot blades 218, 219 the cell 112 in FIGS. 3A to 3S, to produce a desired robot motion to loading a substrate into the process cell P, any horizontal angle change between the main robot linkage and one of the extension arms 212, 214 is half the horizontal angle change between the extension arm 212 or 214 and the respective robot blade 218, 219 through the progression from FIG. 3A to FIG. 3S. For example, the change in the horizontal angle between the main robot linkage 208 and the extension arm 212 is approximately 12 degrees between FIG. 3B and FIG. 3C. By comparison, the change in the horizontal angle between the extension arm 212 and the robot blade 218 is approximately 25 degrees or twice the angle changes between the main robot linkage and the extension arm of 12 degrees. This indicates that using the pulley or gear ratios to produce the robot motions in FIGS. 3A to 3S, any rotation between an extension arm 212, 214 and the main robot linkage is countered by an opposite rotation of half the angle between the same extension arm 212, 214 and the respective robot blade 218, 219. Any other desired ratio may be s elected depending upon the relative configuration of the robot transfer mechanism and the process cells.

Considering the structure of the robot transfer mechanism 132 shown in FIG. 2C, both of these rotations are accomplished by extension of a single extension motor M2 for the first extension arm 212 and the first robot blade 218 (and M3 for second extension arm 214 and the second robot blade 219). To accomplish this type of rotation having the rate of angular rotation of the robot blade being half the rate of angular rotation of the extension arm produced by motor M2, the circumference of the first hub pulley 206 should be twice the circumference of the first extension pulley 236, while the circumference of the first blade pulley 246 is half the circumference of the first extension/blade pulley. A similar ratio of circumference to pulleys 207, 236, 258, and 248 may be provided. The relative dimensions of the pulleys/gears may be altered to provide a modified robot motion.

The structure and operation of the robot transport mechanism 208 has been described. It is envisioned that the concepts and structure can be applied to any robot structure utilizing a plurality of robot blades that can operate independently. For example, the first robotic transfer mechanism 123 shown in FIG. 1 may be configured as a robot transport mechanism as shown in FIGS. 2A to 2F. It is anticipated, however, that these robot blades can be as simple or complex as necessary. For example, the robot blades may be required to support semiconductor substrates in any manner as typically performed in robot transport mechanisms of the prior art.

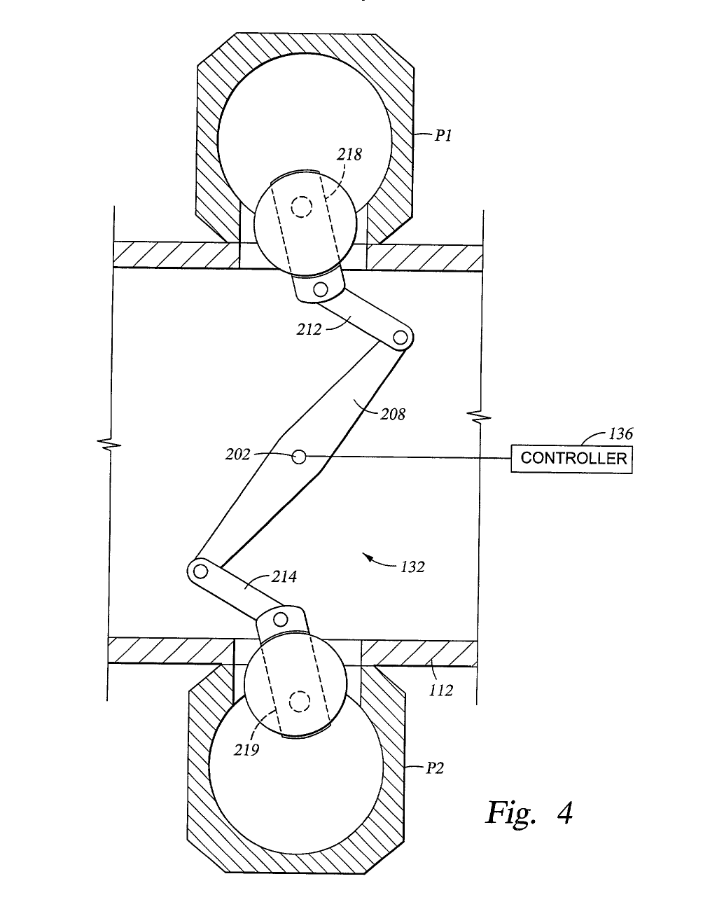

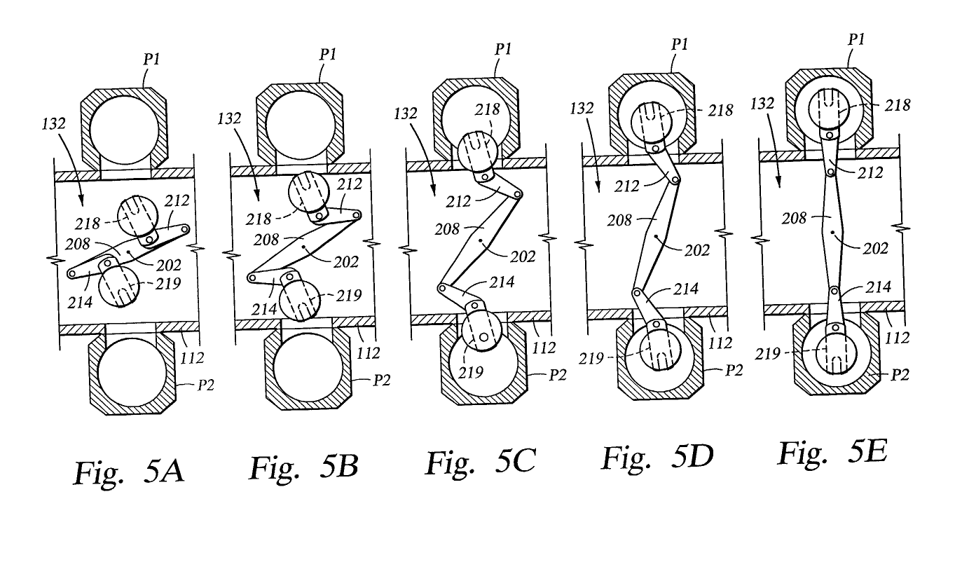

The robot transfer mechanism 132 can be utilized in a variety of different operational applications. For example, FIG. 4 and FIG. 5 (including FIGS. 5A to 5E) utilize a different configuration in which a plurality of process cells P1 and P2 are disposed on opposite sides of the robot hub 202. In the progression if robot motions shown in FIGS. 3A to 3S, described above, provides for the insertion of one of a plurality of robot blades into a single process cell P, while the other robot blade remained in a retracted position to avoid contact with lateral portions of the transfer cell 112, the embodiment of robot transfer mechanism 132 shown in FIGS. 4 and 5 provides for simultaneous insertion of a first robot blade 218 into process cell P1 as the second robot 219 is inserted into process cell P2. Recalling that the first extension motor M2 shown in the embodiment in FIG. 2C provides for the simultaneous extension of the first robot blade 218 and the first extension arm 212, as the second extension motor M3 provides for the simultaneous extension of the second robot blade 219 and extension arm 214. As such, the controller 136 by actuating extension motors M2 and/or M3 can provide respectively for the full extension of either the first blade 218 into the process cell P1 and/or the retraction of the second robot blade 219 from the process cell P2.

In another embodiment of robot motions produced by the robot transport mechanism 132 with a cluster tool shown in FIG. 6, the robot transport mechanism 132 can be utilized to load substrates into process cells P1 and P2 that have process cell openings that are offset from the robot hub. In this configuration, the robot hub 202 is positioned offset from the openings of the process cells P1, P2, P3, and P4. The first robot blade 218 is shown being inserted in a process cell P1 as the second robot blade 219 is shown being inserted into process cell P4. Similarly, the robot blades 218 and 219 can be simultaneously retracted from their respective process cells P1 and P4. The first robot blade 218 and the first robot arm 212 are extended relative to the main robot linkage 208 in a position where the first robot blade 218 is inserted into the process cell P1. This extension of the first robot blade 218 and the first robot arm 212 occurs by actuation of the first extension motor M2 as described above. The second robot blade 219 and the second extension arm 214 can alternatively maintain the second robot blade 219 in its retracted position during the insertion of the first robot blade into process cell P1.

Such alternative applications of the robot transport mechanism 132 does not require the modification of the structure of the robot transport mechanism 132. The alternate applications can be accomplished by mounting the robot transport mechanism 132 relative to the particular process cell(s) with which the robot transport mechanism 132 interacts. The robot motion of the main robot linkage 208, the robot arms 212, 214, and the robot blades 218, 219 is then accurately controlled.

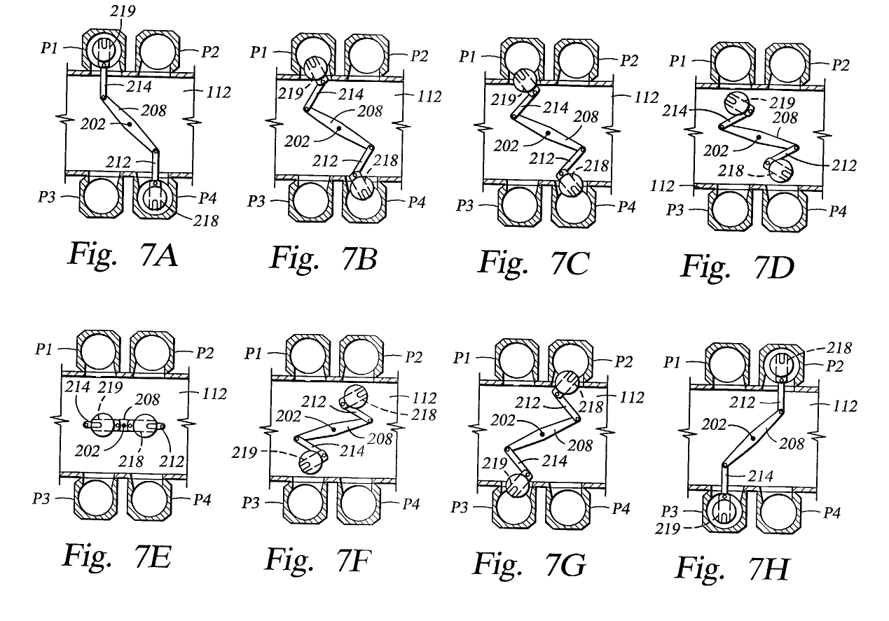

FIG. 7 (including FIGS. 7A to 7F) shows a progression of displacements of the robot transfer mechanism 132 that allows for such simultaneous extension of multiple robot blades 218, 219 into their respective process cells P1 and P2. FIG. 5A displays a position in which the main robot linkage 208 is partially rotated while both the combination of the first extension arm 212 and the first robot blade 218 in their retracted positions with the combination of the second extension arm 214 and the second robot blade 219 in their retracted positions. Maintaining the respective extension arms and robot blades in their retracted position through this initial rotation is provided to maintain the substrates being held by the respective robot blades 218, 219 closely aligned with a line extending from the middle of process cell P1 to the middle of process cell P2 (and passing through robot hub 202) as practicable.

As the main robot linkage 208 continues its counter clockwise rotation, through the position shown in FIG. SB, the extension motors M2 and M3, shown in FIG. 2C, are both simultaneously actuated to simultaneously extend the first extension arm/first robot blade 218 and the second extension arm 214 and second robot blade 219 to the respective process cells P1, P2. Such displacement of the extension arms 212, 214, and the robot blades 218, 219 caused by extension motors M2 and M3 continue all the way through FIG. 5E, in which the main robot linkage 208, the extension arms 212, 214, and the robot blades 218, 219 are all aligned with an imaginary line extending from the center of the process cell P1 through the center of the process cell P2 with the opening of the process cells P1 and P2 aligned with the opening.

Another embodiment of the application of the robot transfer mechanism 132 is shown in the embodiment of transfer chamber 112 shown in FIG. 6. The embodiment of robot transfer mechanism 132 shown in FIG. 6 allows for the insertion of a plurality of substrates into a plurality of process cells P1 and P4, simultaneously. If an imaginary line were drawn from the center of process cell P1 through the robot hub 202, the imaginary line would not be aligned with the opening of the process cell P1 to P4. The openings of process cells P1 and P4 are not directed toward the robot hub 202.

To provide this simultaneous insertion of robot blades 218 and 219 into respective process cells P1 and P4, the robot transfer mechanism 132 is configured within the transfer cell to be disposed at an angle from vertical as indicated in FIG. 6. This configuration provides the lateral offset between the respective first extension arm 212 and the first robot blade 218 from the second extension arm 214 and the second robot blade 219. This lateral offset of the robot blades 218, 219 results from the angle from vertical of the main robot linkage 208 compensates for the offset of the process cell P1 and P4.

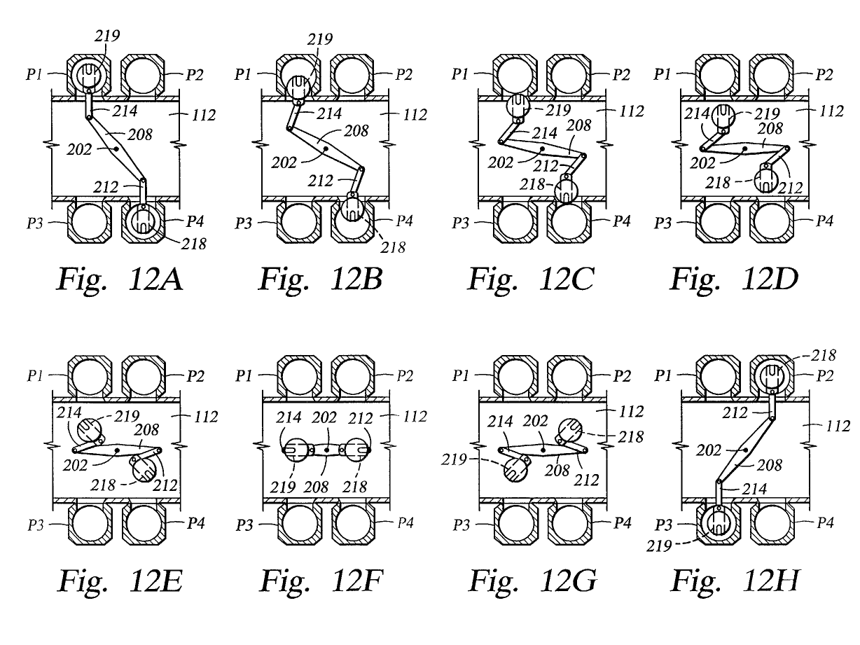

The FIG. 10 embodiment of robot transfer mechanism 132, that utilizes five motors M1, M2, M3, M4, and MS, may be operated differently from the embodiments utilizing three motors M1 to M3 to provide a varied robot motion as shown in FIG. 12. The structure and operation of motors M1, M2, and M3 are similar to that described for those respective similarly numbered motors in the embodiment shown in FIGS. 2C and 8. The addition of motors M4 and MS provides for an increased control of motion of each robot blade relative to the respective extension arm, and with respect to the main robot linkage 208. Any of the motors M1 to MS can be operated independently, or simultaneously, to provide the desired robot motions.

As shown in FIG. 12, including FIGS. 12A to 12H, the embodiment of robot transfer mechanism 132 provides for a variety of motions. The embodiment of robot mechanisms shown in FIGS. 2C, 8, and 9 could be configured to provide the type of robot motion shown in FIGS. 3A to 3S, 5A to 5F, and 7A to 7H. However, FIG. 10 embodiment of robot transfer mechanism allows for the relative transfer and relative angle of the robot blades, the extension arms, and the main robot body wherein the robot blade can independently move a robot blade 218 or 219 relative to a respective extension arm 208 or 209 by actuation of a respective motor M4 or M5. For example in FIG. 12 a, the robot transfer mechanism 132 is initially configured with the second robot blade 219 inserted in the process cell P and the first robot blade 218 inserted in process cell P4. The motions of the robot transfer mechanism 132 is shown wherein the second robot blade is removed from process cell PI one of the first robot blade 218 is removed from process cell P4 is shown in the progression from FIGS. 12A to 12F.

The independent motions of motors M4 can thus be applied to displace the first robot blade 218 to the opposed process cell P2 as shown in FIG. 12H compared to the process cell P4 that it is shown in FIG. 12A. Such displacement could provide displacement of the first robot blade between process cells P4 and P2, and displacement of the second robot blade 219 between process cells P3 and P2.

The embodiments of robot transfer mechanism 132 can provide such robot motion that any of the robot blades can be inserted into, or removed from, any of the process cells shown in the embodiments of transfer cells shown in FIGS. 3A to 3S, 4, 5A to 5E, 6, 7A to 7H, and 12A to 12H. Such insertions of, or removals of, the desired robot blades 218 or 219 into any of the desired process cells may be provided by suitable selection relative pulley dimensions (sized to allow for the relative extension arm/robot blade/main robot linkage configurations) to provide the desired extension arm/robot blade motion, or alternatively the use of multiple motors M1 to M5.

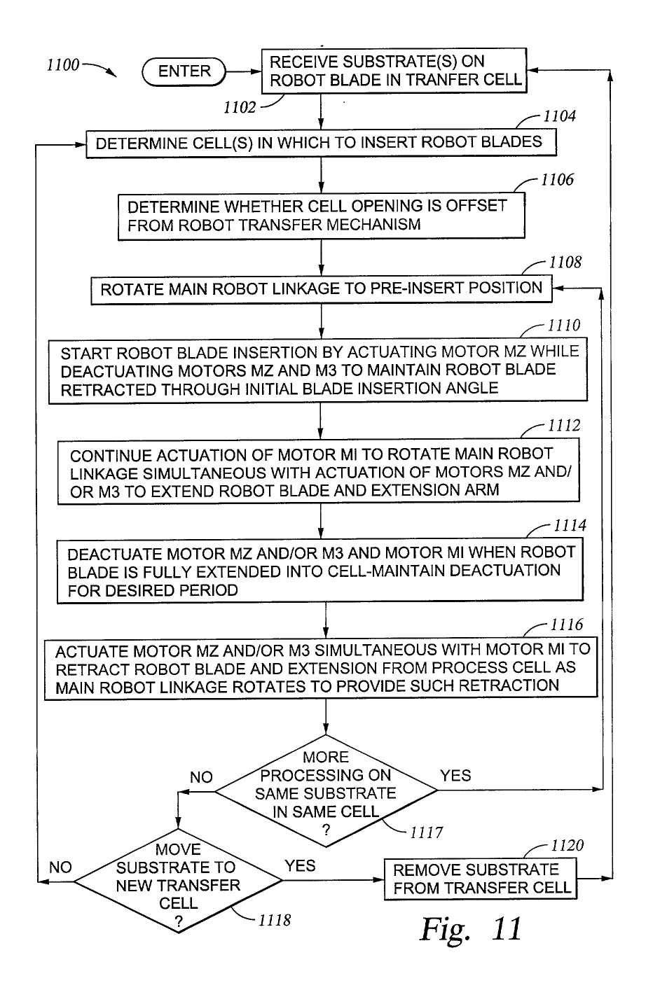

FIG. 11 shows one embodiment of method 1 100 performed by the controller 136 shown in FIG. 1 to provide some of the described robot motions. The method 1100 starts with block 1102 in which one, or more, substrates are received on the robot blades 218, 219 of the robot transfer mechanism 132, within the transfer cell 112, from either the cool down cell 102 or the pre-clean cell 114. In this embodiment of method 1100, the transfer cell is considered to be that cell in which the robot transfer mechanism 132 is located. The cells in method 1100 are considered to be those cells that open onto the transfer cell.

The method 1100 continues to block 1104 in which it is determined into which cell to insert one or more of the robot blade 218, 219. This determination is determined based primarily upon the order of processing that the substrates are to undergo within the cluster tool 100. As such, robot blades may be inserted into any specific cell to deposit a substrate into that cell, to remove a substrate from that cell, or to displace a substrate to another position within that cell. Following block 1104, the method continues to block 1106 in which it is determined whether the cell opening is offset from the robot hub of the main frame transfer mechanism 132.

The controller 136 has stored in memory the relative position of each cell relative to the transfer cell, and additionally the offset angle of each cell opening onto the transfer cell relative to the robot transfer mechanism. As such, when the controller 136 performs the method 1100 shown in FIG. 11, and it is determined which cells to insert the robot blades into, the controller 136 also provides the angle of the cells relative to the robot transfer mechanism, and additionally the offset opening angle of the each cell opening relative to the transfer cell and the robot transfer mechanism. Such cell opening offset information is useful in determining how the motors M1, M2, and M3 (and M4 and M5 in the embodiment shown in FIG. 10 should be actuated in order to insert a respective robot blade into the process cell without contacting the edge of the opening of that cell.

The method 1100 in FIG. 11 then continues to block 1108 in which the main robot linkage 208 of the robot transfer mechanism 132 is rotated to a pre-robot blade insert position relative to the cell P that is desired to insert the robot blade into. Such rotation of the main robot linkage 208 is affected by actuation of the extension motor M1. The method 1100 continues onto block 1110 in which motor M1 is actuated to commence to start the robot blade insertion. Typically during the initial phases of the robot blade insertion, the respective extension motor M2 or M3 that acts to extend the extension arm or robot blade, is deactuated so both the robot blades and both the extension arms are maintained in their retracted positions during this initial blade insertion angle. An example of this initial blade of the rotation of the main robot linkage through an initial blade insertion angle while keeping the respective robot blades and extension arms are retracted are shown in FIGS. 3A to 3B.

The method 1100 continues to block 1112 in which motor M1 continues to be actuated to rotate the main robot linkage through its desired angle. During block 1112, the respective extension motors M2 and/or M3 are actuated to simultaneously extend the respective robot blade and extension arm into their extended positions, to extend the robot blade into the process cell as the main robot linkage is being rotated. Such continued actuation of motors M2 and/or M3 in combination with the actuation of motor M1 continues until block 1114 in which motors M2, M3, and M1 are deactuated. The deactuation of motors M1, M2, and M3 (or motors M1 to M5 in the embodiment of robot transfer mechanism shown in FIG. 12) occur when the robot blade and extension arm are fully extended in the desired position into the cell.

The relative positions of the main robot linkage, the respective extension arm 212, 214, and the respective robot blade 218, 219 to insert one or more of the respective blades 218, 219 into any particular process cell P depends upon the angle of the cell opening P within the transfer cell 112, and additionally the angle of the opening of the cell is directed at relative to the robot transfer mechanism 132 (i.e., the offset of the cell). Block 114 is maintained during the desired time that it takes to either unload the substrate from the robot blade, or load a substrate unto the robot blade, considering the specific mechanism utilized within the cell. The method 1100 continues to block 1116 in which the robot blade is retracted from the cell P. Such retraction of the robot blade is effected within the robot transfer mechanism 132 by the simultaneous actuation of motors M2 and/or M3 in combination with motor M1.

The method 1100 continues to decision block 1117 in which the controller determines whether more substrate processing is required on that particular substrate. For example, the first pass through blocks 1108, 1110, 1112, 1114, 1116, and decision block 1117 may be performed to insert a substrate into a particular process cell, and remove the robot blade from the process cell to permit the substrate to be processed within the process cell. It may be necessary following the decision block 1117 to continue to loop through blocks 1108, 1110, 1112, 1114, 1116, and decision block 1117 once again in order to insert the robot blade into the process cell following processing of the substrate in the process cell to remove the processed substrate from the process cell. During the first loop through, when the substrate is being inserted into the process cell, the answer to decision block 1117 would be yes. During the second loop through, when the substrate is being removed from the process cell following processing, the answer to decision block 1117 would be no, and the method 1100 would continue onto decision block 1118.

In decision block 1118, the controller determines whether to move the substrate(s) to a new transfer cell. Such transfer of the substrate to a new transfer cell may occur following the completion of the processing on the substrate, or alternatively, the substrate may be transferred from the process cell to be measured, cleaned, undergo a spin-rinse-dry process or the like. If the answer to decision block 1118 is no, the method continues to loop back to decision block 1104. In block 1104 the assumption by following this route back to block 1104 is that the substrate will be processed within another process cell within the transfer cell 112, and as such has to be displaced accordingly. If the answer to decision block 1118 is yes, the method 1100 continues to block 1120 in which the substrate is transferred from the transfer cell 112. Following the transfer of this substrate from the transfer cell 112, the robot transfer mechanism 132, under the control of the controller 136, receives one or more substrate(s) on the robot blade in the transfer cell, as per block 1102. As such, the robot transfer mechanism continues its processing on a new substrate, or new set of substrates.

Although various embodiments that incorporate the teachings of the present invention have been shown and described in detail herein, those skilled in the art can readily devise many other varied embodiments that still incorporate these teachings.

1. A robot apparatus to be mounted on a robot hub, the robot apparatus comprising:
a main robot link fixedly mounted to the robot hub;
a first robot extension arm rotatably mounted to a first end of the main robot link;
a second robot extension arm rotatably mounted to a second end of the main robot link, the first end of the main robot link being located on a distal end of the main robot link from the second end of the main robot link;
a first robot blade being mounted to the first robot extension arm;
a second robot blade being mounted to the second robot extension arm;
a hub motor providing controllable rotational motion of the main robot link about the robot hub;
a first extension motor configured to provide controllable simultaneous extension or retraction of the first robot extension arm and the first robot blade; and
a second extension motor configured to provide controllable simultaneous extension or retraction of the second robot extension arm and the second robot blade.

2. The robot apparatus of claim 1, wherein the hub motor includes a stepper motor.

3. The robot apparatus of claim 1, wherein the hub motor includes an electromechanical motor.

4. The robot apparatus of claim 1, wherein the hub motor comprises one from the list of gear transmission system or friction transmission system.

5. The robot apparatus of claim 1, wherein the main robot linkage is a unitary structure.

6. The robot apparatus of claim 1, wherein each of the plurality of hub motor, first extension motor, and second extension motor are independently controllable.

7. The robot apparatus of claim 1, wherein the first robot blade and the second robot blade are each configured to be inserted in a cell.

8. The robot apparatus of claim 1, further comprising a first pulley arrangement that transfers output motion from the first extension motor to simultaneous angular rotation of the first extension arm and angular rotation of the second robot blade.

9. The robot apparatus of claim 8, wherein the first pulley arrangement provides for angular rotation of the first extension arm that occurs at a fixed rate compared to the rate of the angular rotation of the second robot blade.

10. The robot apparatus of claim 8, wherein the first pulley arrangement provides for angular rotation of the first extension arm at a rate that is twice the rate of the angular rotation of the second robot blade.

11. A robot apparatus to be mounted on a robot hub, the robot apparatus comprising:
a main robot link fixedly mounted to rotate about the robot hub;
a hub motor capable of providing controllable rotational motion to the main robot link about the robot hub;
a first extension hub being rotatably mounted to a first side of the main robot link;
a second extension hub being rotatably mounted to a second side of the main robot link, the second side being on an opposed side of the robot link from the first side;
a first extension arm being mounted to the first extension hub;
a second extension arm being mounted to the first extension hub;
a first robot blade hub being rotatably mounted to a distal location of the first robot arm from the first extension hub;
a second robot blade hub being rotatably mounted to a distal location of the second robot arm from the second extension hub;
a first robot blade mounted to the first robot blade hub;
a second robot blade mounted to the second robot blade hub;
a first extension motor configured to provide a first controllable simultaneous extension or a first controllable simultaneous retraction of the first extension arm about the first extension hub and the first robot blades about the first robot blade hub; and
a second extension motor configured to provide a second controllable simultaneous extension or a second controllable simultaneous retraction of the second extension arm about the second extension hub and the second robot blades about the second robot blade hub.

12. The robot apparatus of claim 11, wherein the second controllable simultaneous extension or the second controllable simultaneous retraction occurs respectively independently of the first controllable simultaneous extension or the first controllable simultaneous retraction.

13. The robot apparatus of claim 11, wherein the second controllable simultaneous extension or the second controllable simultaneous retraction occurs respectively dependently of said first controllable simultaneous retraction or the first controllable simultaneous extension.

14. The robot apparatus of claim 11, wherein the robot apparatus is designed to insert the first robot blade or the second robot blade sequentially into a single process cell.

15. The robot apparatus of claim 11, wherein the hub motor includes a stepper motor.

16. The robot apparatus of claim 11, wherein the hub motor includes an electromechanical motor.

17. The robot apparatus of claim 1 1, wherein the hub motor comprises one from the list of gear transmission system or friction transmission system.

18. The robot apparatus of claim 11, wherein the main robot linkage is a unitary structure.

19. The robot apparatus of claim 11, wherein each of the plurality of hub motor, first extension motor, and second extension motor are independently controllable.

20. The robot apparatus of claim 11, wherein the first robot blade and the second robot blade are each configured to be inserted in a cell.

21. The robot apparatus of claim 11, further comprising a first pulley arrangement that transfers output motion from the first extension motor to simultaneous angular rotation of the first extension arm and angular rotation of the second robot blade.

22. The robot apparatus of claim 21, wherein the first pulley arrangement provides for angular rotation of the first extension arm that occurs at a fixed rate compared to the rate of the angular rotation of the second robot blade.

23. The robot apparatus of claim 21, wherein the first pulley arrangement provides for angular rotation of the first extension arm at a rate that is twice the rate of the angular rotation of the second robot blade.

24. A method of providing a robot motion to a dual-bladed robot including a main robot linkage, a first extension arm and a connected first robot blade displacably mounted to a first side of the main robot linkage, and a second extension arm and a connected second robot blade displacably mounted to a second side of the main robot linkage, the method comprising:
initially rotate the main robot link so the first extension arm and the first robot blade are in an initial aligned position with a first process cell, during the initial rotation both the first extension arm and the first robot blade remain in their retracted positions;
continue rotation of the main robot link to insert the first robot blade in the first process cell, during the continued rotation the first extension arm and the first robot blade simultaneously extend into their respective extended positions.

25. The method of claim 24, wherein an opening of the first process cell is aligned with the dual bladed robot.

26. The method of claim 24, wherein an opening of the first process cell is offset from the dual bladed robot.

27. The method of claim 24, wherein when the main robot link, the first extension arm, and the first robot blade are fully rotated into their respective extended positions with the main robot link aligned with the first process cell, the first robot blade is inserted the first process cell.

28. The method of claim 24, wherein: during the initial rotation of the main robot link, the second extension arm and the second robot blade are in an initial aligned position with a second process cell, during the initial rotation both the second extension arm and the second robot blade remain in their retracted positions; and
during the continued rotation the second extension arm and the second robot blade simultaneously extend into their respective extended positions.

29. The method of claim 24, wherein when the main robot link, the second extension arm, and the second robot blade are fully rotated into their respective extended positions when the main robot link is aligned with the second process cell, the second robot blade is inserted into the second process cell.
